(19) United States
(12) Patent Application Publication
(10) Pub. No.: US 2024/0412321 A1
(43) Pub. Date: Dec. 12, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SATORU MAMIYA, Kanagawa (JP)

(21) Appl. No.: 18/678,758

(22) Filed: May 30, 2024

(30) Foreign Application Priority Data
Jun. 12, 2023 (JP) 2023-096466

(51) Int. Cl. G06T 3/20; G06T 7/246; G06T 7/73

(52) U.S. Cl. CPC G06T 3/20; G06T 7/248; G06T 7/74

(57) ABSTRACT

An obtaining unit obtains first position information indicating a position of a target detected in a first image captured of a target object and second position information indicating a position of the target detected in a second image captured of the target object at a different time from the first image. A estimating unit estimates a position shift amount of the target on a basis of the first position information and the second position information. A correcting unit corrects at least one of the first position information and the second position information on a basis of the position shift amount. The first position information includes information of each vertex of the target in the first image, and the second position information includes information of each vertex of the target in the second image.

### BACKGROUND OF THE INVENTION

### Field of the Invention

The present invention relates to an information processing apparatus, an information processing method, and a storage medium.

### Description of the Related Art

In recent years, to optimize the task of inspecting aging social infrastructure construction in Japan, the soundness of a construction is evaluated using an inspection image captured with an inspection target as the subject. With this technique, damage in the inspection image is extracted as polylines (vector data) by tracing by a worker or by image checking using machine learning and evaluated taking into consideration the state of the damage such as the position, shape, size, number, density, and the like and the comparative progress over time.

In a case where the construction is a tunnel, for example, the cross section with respect to the forward direction is usually a circumferential shape, and the lining surface, which is the curved surface portion following the circumference, corresponds to the main inspection target. A method of efficiently obtaining a high definition inspection image of a wide region such as a tunnel lining surface includes driving a car with a plurality of cameras attached facing the target and combining the captured image data via digital processing. Such methods are constantly improving with the camera used changing from a video camera to a line sensor camera with higher definition and with the introduction of drones for capturing images of bridges and the like. Thus, with the most recently obtained inspection image and the previous inspection image targeted for change over time comparison, there is a possibility that the imaging conditions such as the camera type, field of view, number of cameras, or the like are different. Also, even if these conditions are the same, there may be a difference in the field of view covered by each camera if the movement path at the time of imaging is different. This may result in a difference in the processing results when combining the captured images and in a position shift across inspection images due to the obtaining time period even with the same target, making comparison of the extract damage difficult.

An example of a method for enabling comparison by correcting position shift across images captured of the same target is described in Japanese Patent Laid-Open No. H7-37074. This technique relating to the medical field includes aligning chest X-ray images.

### SUMMARY OF THE INVENTION

According to one embodiment of the present invention, an information processing apparatus, comprises: at least one processor; and a memory configured to combine with the at least one processor, and when executed by the processor, the memory includes a command for executing operations as: an obtaining unit configured to obtain first position information indicating a position of a target detected in a first image captured of a target object and second position information indicating a position of the target detected in a second image captured of the target object at a different time from the first image; a estimating unit configured to estimate a position shift amount of the target on a basis of the first position information and the second position information; and a correcting unit configured to correct at least one of the first position information and the second position information on a basis of the position shift amount, wherein the first position information includes information of each vertex of the target in the first image, and the second position information includes information of each vertex of the target in the second image.

According to another embodiment of the present invention, an information processing method, comprises: obtaining first position information indicating a position of a target detected in a first image captured of a target object and second position information indicating a position of the target detected in a second image captured of the target object at a different time from the first image; estimating a position shift amount of the target on a basis of the first position information and the second position information; and correcting at least one of the first position information and the second position information on a basis of the position shift amount, wherein the first position information includes information of each vertex of the target in the first image, and the second position information includes information of each vertex of the target in the second image.

According to yet another embodiment of the present invention, a non-transitory computer readable storage medium stores a program that, when executed by a computer, causes the computer to perform a information processing method, the information processing method comprising: obtaining first position information indicating a position of a target detected in a first image captured of a target object and second position information indicating a position of the target detected in a second image captured of the target object at a different time from the first image; estimating a position shift amount of the target on a basis of the first position information and the second position information; and correcting at least one of the first position information and the second position information on a basis of the position shift amount, wherein the first position information includes information of each vertex of the target in the first image, and the second position information includes information of each vertex of the target in the second image.

Further features of the present invention will become apparent from the following description of exemplary embodiments (with reference to the attached drawings).

### BRIEF DESCRIPTION OF THE DRAWINGS

FIG. 1A is a block diagram illustrating an example of the hardware configuration of an information processing apparatus.

FIG. 1B is a block diagram illustrating an example of the functional configuration of the information processing apparatus.

FIG. 2 is a diagram for explaining a tunnel to be inspected and an inspection image.

FIGS. 3A and 3B are diagrams for explaining the state of capturing inspection images of a tunnel.

FIGS. 4A and 4B are diagrams for explaining polyline data.

FIGS. 4C and 4D are diagrams for explaining the coordinates of the vertices of polyline data.

FIG. 4E is a diagram for explaining the superimposed display of polyline data.

FIG. 5 is a flowchart illustrating an example of pattern image generation processing.

FIGS. 6A to 6C are diagrams for explaining a template region.

FIGS. 7A and 7B are diagrams for explaining processing for determining a target region.

FIGS. 8A to 8C are diagrams for explaining polyline drawing.

FIG. 9 is a flowchart illustrating an example of shift vector calculation processing.

FIGS. 10A and 10B are diagrams for explaining template matching executed by the information processing apparatus.

FIGS. 11A and 11B are diagrams for explaining shift vector calculation processing.

FIG. 12 is a flowchart illustrating an example of transformation function generation processing.

FIGS. 13A and 13B are graphs where the positional relationship between pre-transformation coordinates and shift vectors are plotted.

FIG. 14 is a diagram illustrating an example of post-transformation polyline data superimposed display.

FIG. 15 is a diagram for explaining polyline data of a divided template.

FIG. 16 is a diagram for explaining a case where there are a plurality of score peaks.

FIG. 17 is a block diagram illustrating an example of the functional configuration of an information processing apparatus according to a second embodiment.

FIGS. 18A to 18D are diagrams for explaining the GUI displayed by the information processing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Using high definition captured images as the inspection images for comparison in the evaluation of the soundness of a construction or the like increases the cost of processing and storage due to the large data amount.

Embodiments of the present invention provide an information processing apparatus that reduces the cost of correcting a shift between detected targets in images captured at different times.

### First Embodiment

An information processing apparatus according to the present embodiment obtains first position information indicating the position of a target detected in a first image captured of a target object and second position information indicating the position of the target detected in a second image captured of the target object at a different time from the first image. Next, the information processing apparatus estimates the position shift amount of the target on the basis of the obtained first position information and the second position information and corrects at least one of the first position information and the second position information on the basis of the position shift amount.

For example, the information processing apparatus according to the present embodiment can obtain from both the first image and the second image, as the first position information and the second position information, a polyline data group including one or more piece of polyline data in which the shape of the target is indicated by information of each vertex. In this case, the information processing apparatus generates a function for transforming the coordinates in a coordinate system of first polyline data to coordinates in a coordinate system of second polyline data on the basis of the position shift amount estimated from the polyline data and transforms the coordinates indicated by the first polyline data using the generated function. The first polyline data and the second polyline data will be described below.

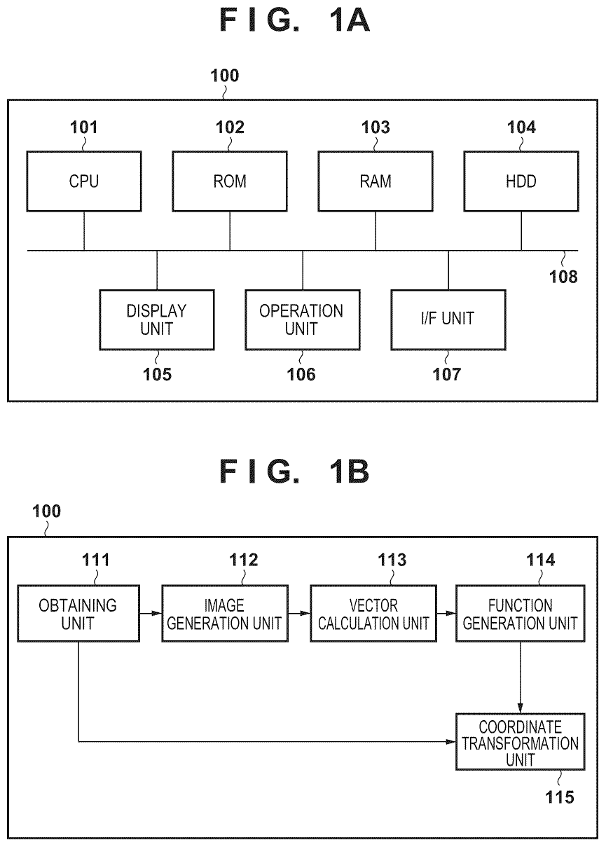

FIG. 1A illustrates an information processing apparatus according to the present embodiment. An information processing apparatus 100 includes a CPU 101, a ROM 102, a RAM 103, a HDD 104, a display unit 105, an operation unit 106, and an I/F unit 107. The CPU 101 is a central processing unit that executes arithmetic and logical decisions for the processing and controls the components connected to a system bus 110. The read-only memory (ROM) 102 is program memory for storing a program for control by the CPU 101 including the various types of processing described below. The random access memory (RAM) 103 is used as the main memory of the CPU 101 or as a temporary storage area such as a working area. Note that the program memory may be implemented by the program being loaded onto the RAM 103 from the HDD 104, an external storage apparatus connected to the information processing apparatus 100, or the like.

The HDD 104 is a hard disk for storing electronic data such as image data or programs relating to the present embodiment. Note that an external storage apparatus may be used to achieve a similar function to the HDD 104. Here, an external storage apparatus, for example, can be implemented by media (a storage medium) and an external storage drive for implementing access to the media. A flexible disk (FD), a CD-ROM, a DVD, a USB memory, a solid state drive (SSD), or the like may be used as the media. Also, the external storage apparatus may be a server apparatus connected to a connect or a similar apparatus external to the information processing apparatus 100.

The display unit 105 is a liquid crystal display (LCD) or an organic EL display (OLED) that outputs images on a display screen, for example. Note that the display unit 105 may be an external apparatus connected to the information processing apparatus 100 via a wired or wireless connection. The operation unit 106 is a keyboard and mouse, for example, and accepts various types of operations from the user. Note that the operation unit 106 is not particularly limited, and any device that can accept input from a user may be used, with examples including a touch panel and a microphone. The I/F unit 107 performs communication in both directions with another information processing apparatus, a communication device, or an external storage apparatus via a wired or wireless connection using a known communication technique.

FIG. 1B is a block diagram illustrating an example of the hardware configuration of the information processing apparatus 100. The functional units illustrated in FIG. 1B are implemented by the CPU 101 loading programs stored in the ROM 102 onto the RAM 103 and executing processing according to each flowchart described below.

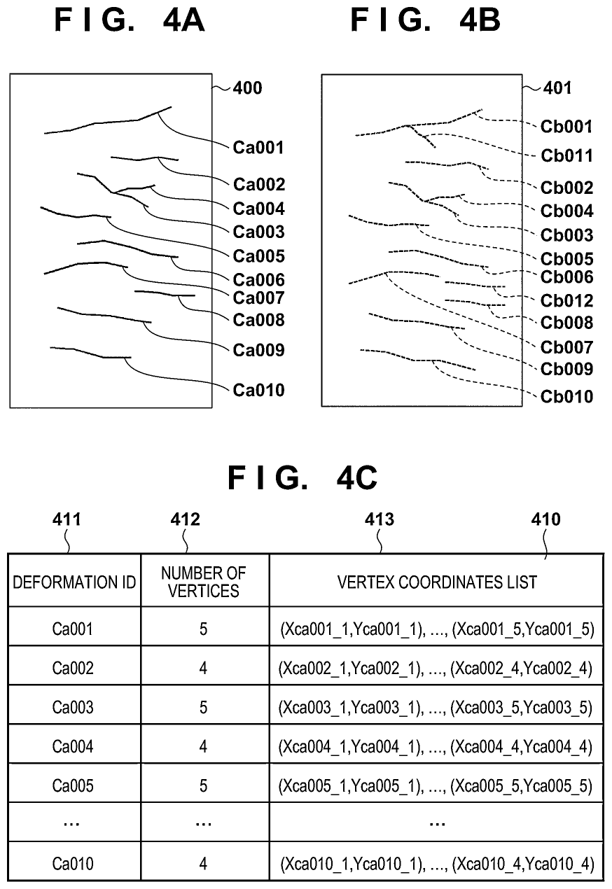

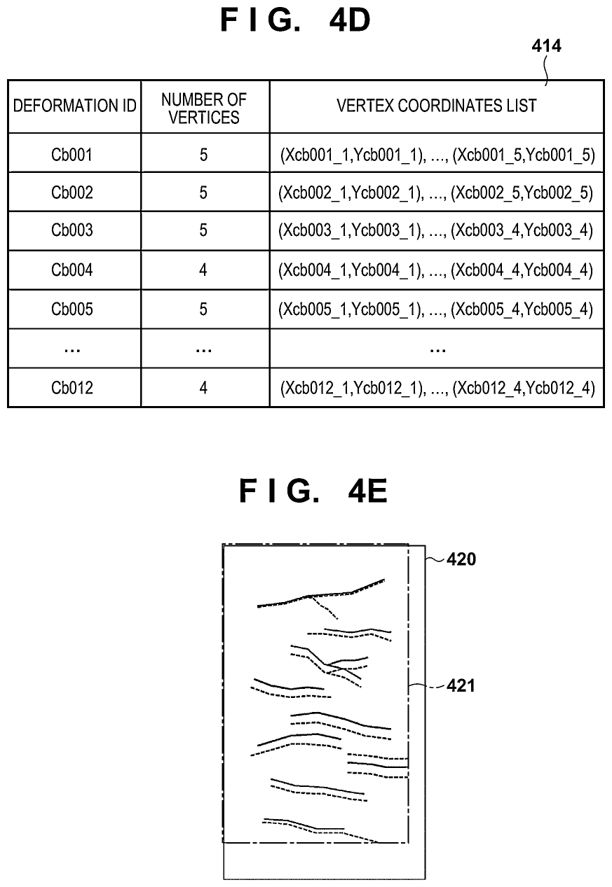

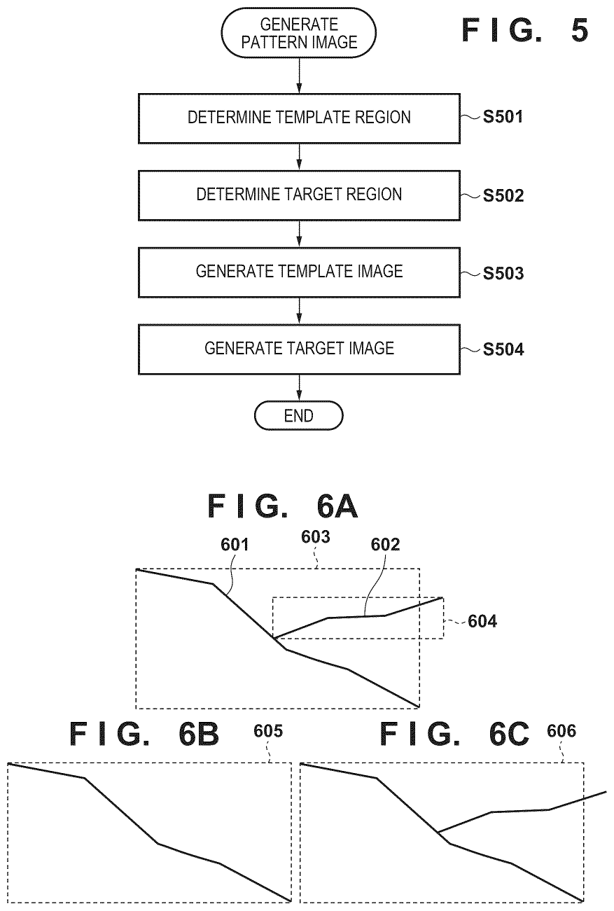

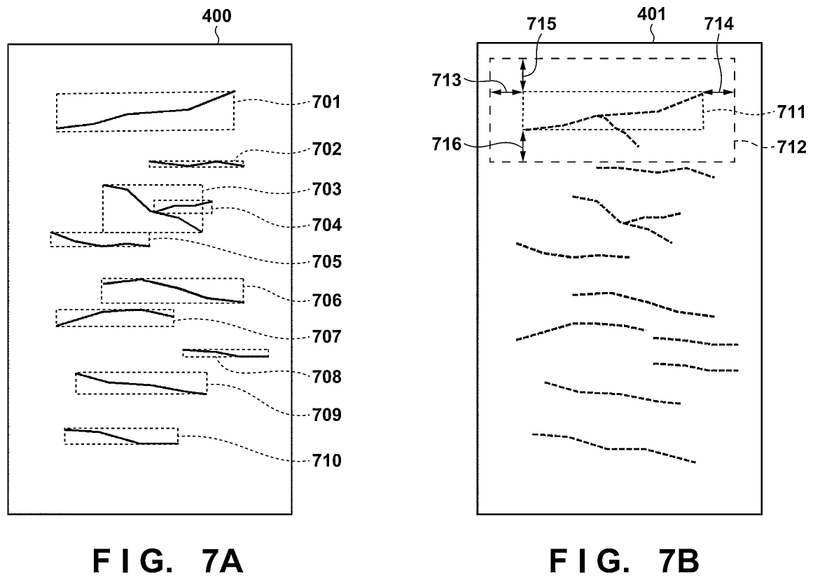

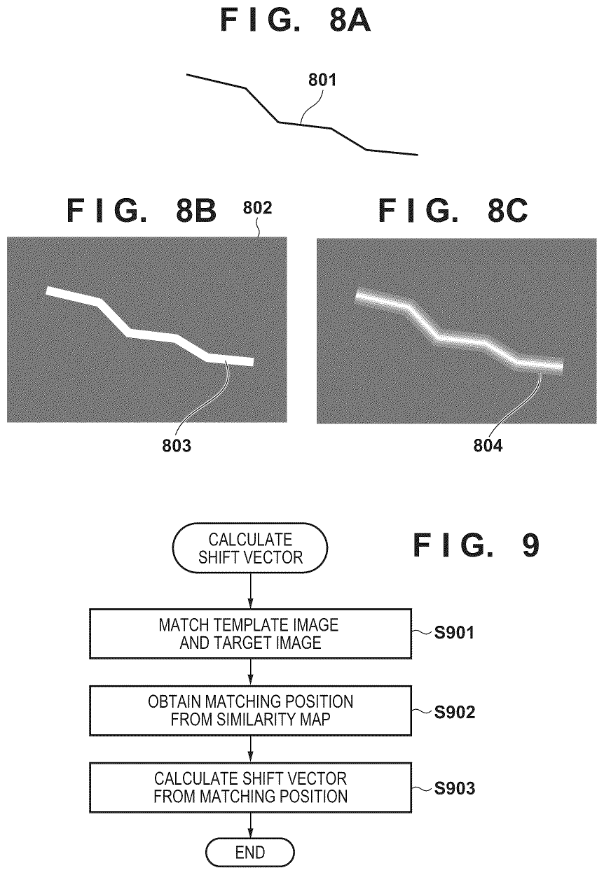

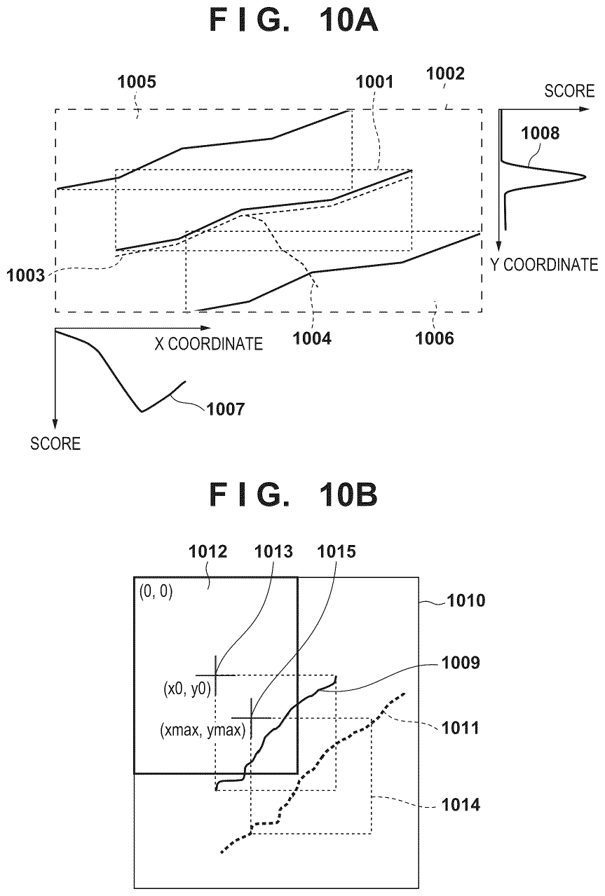

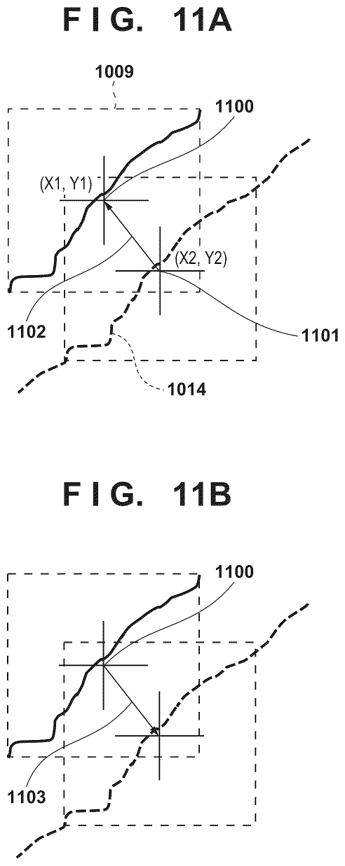

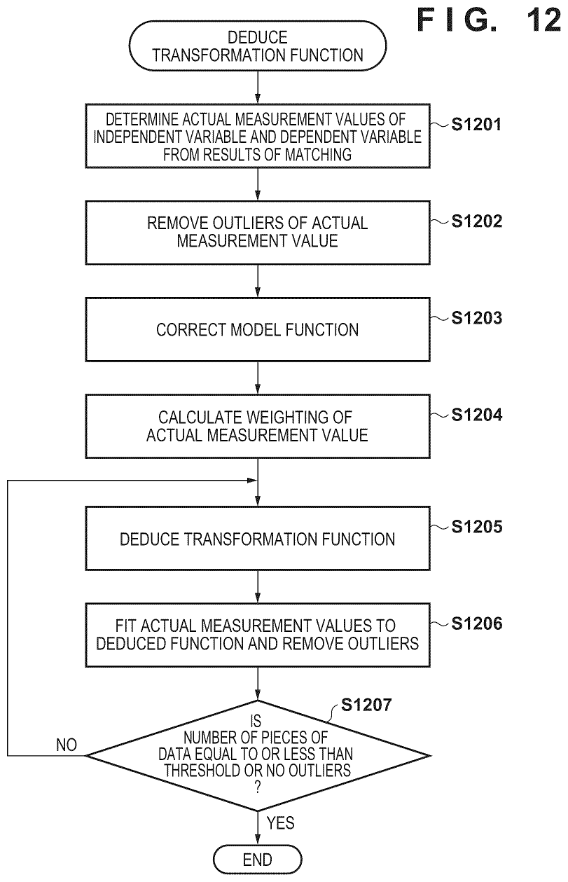

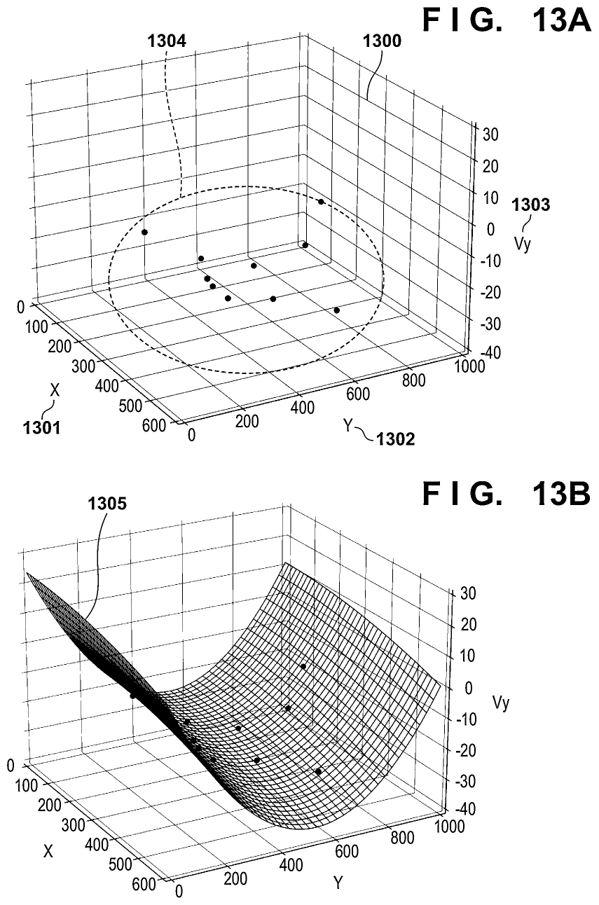

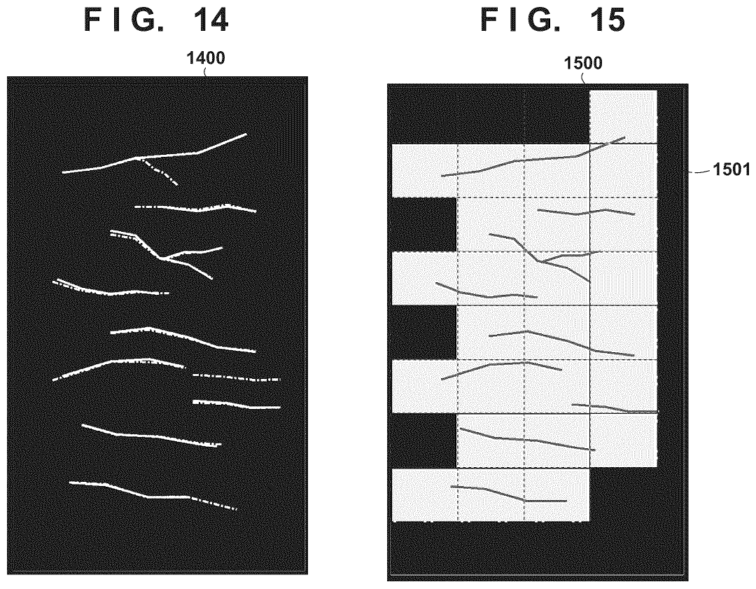

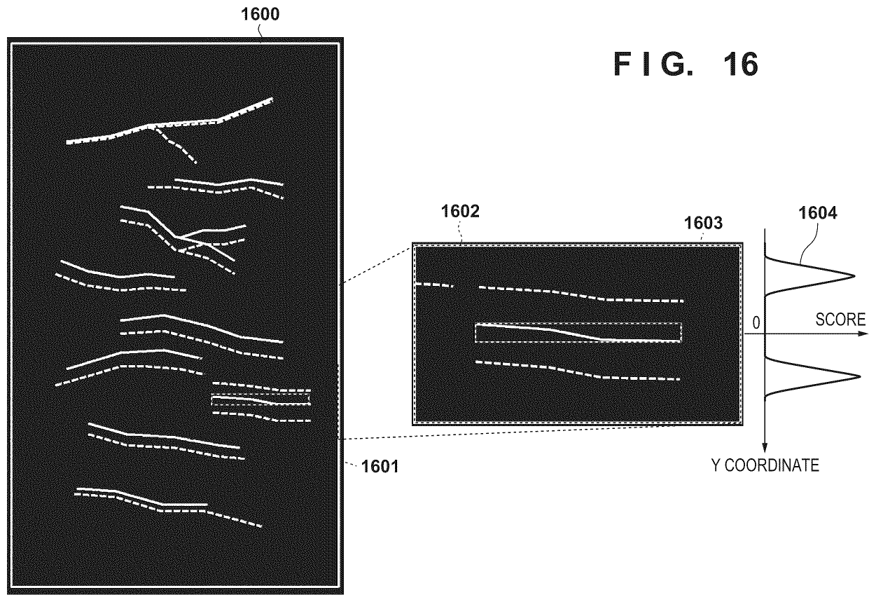

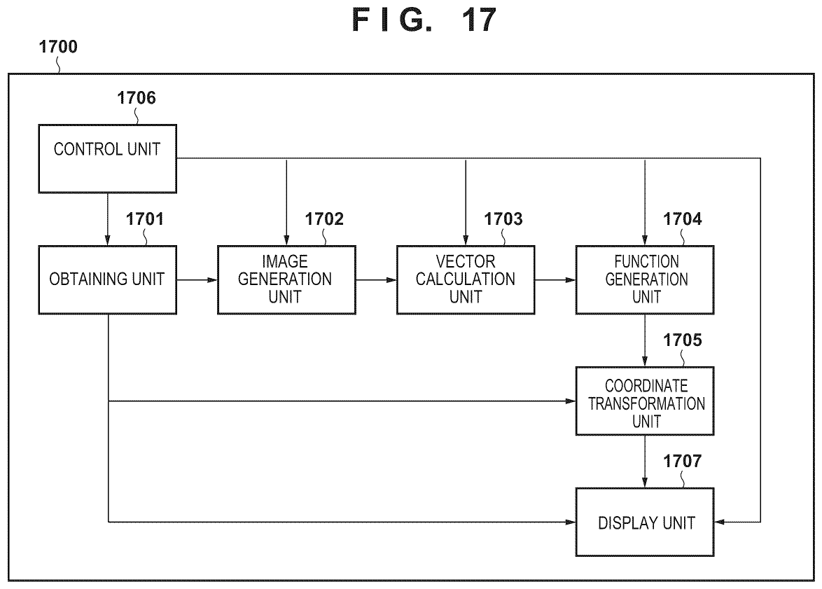

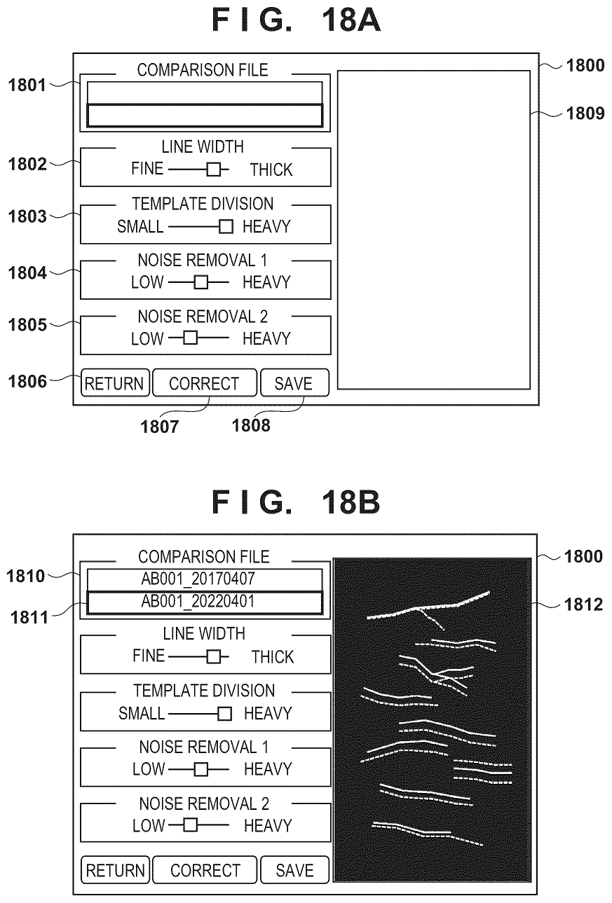

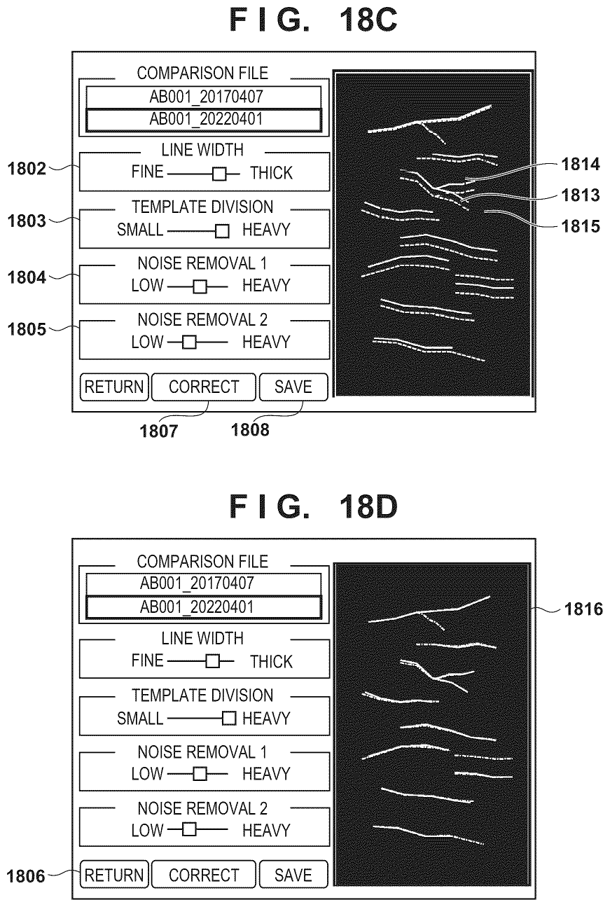

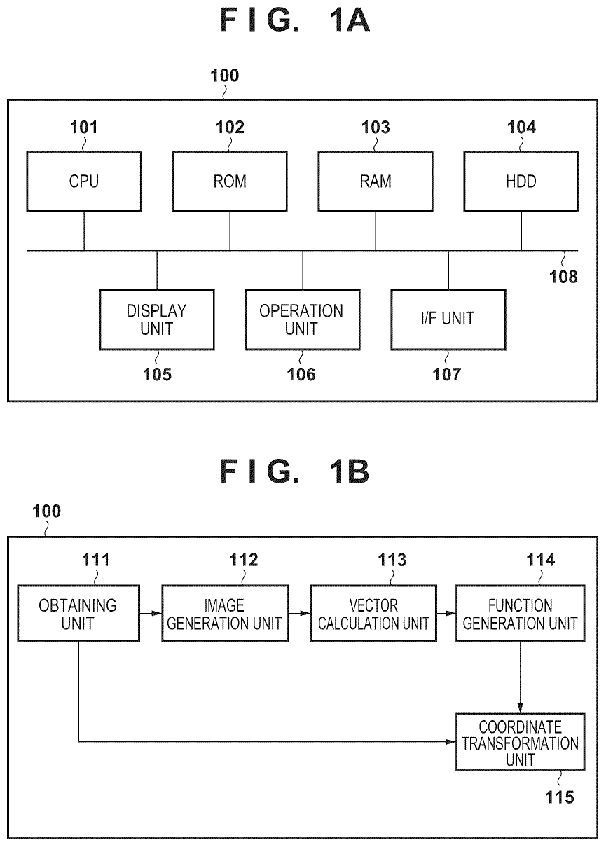

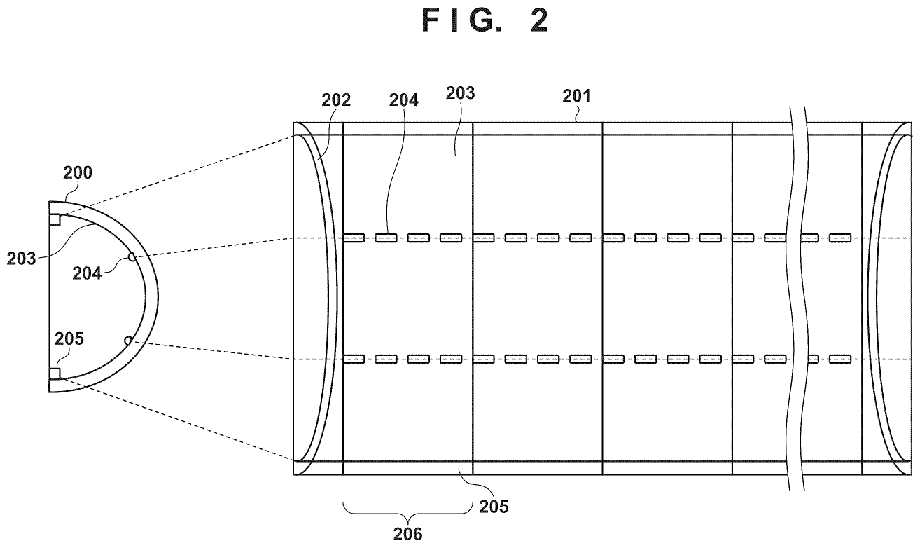

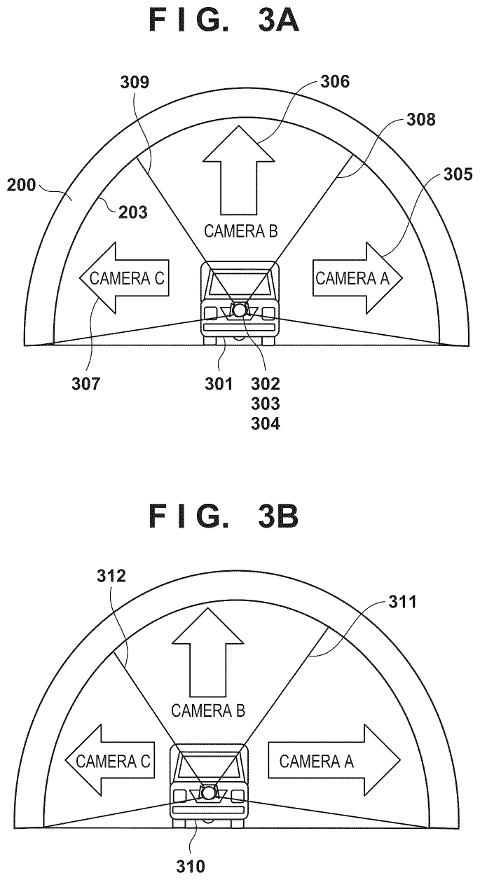

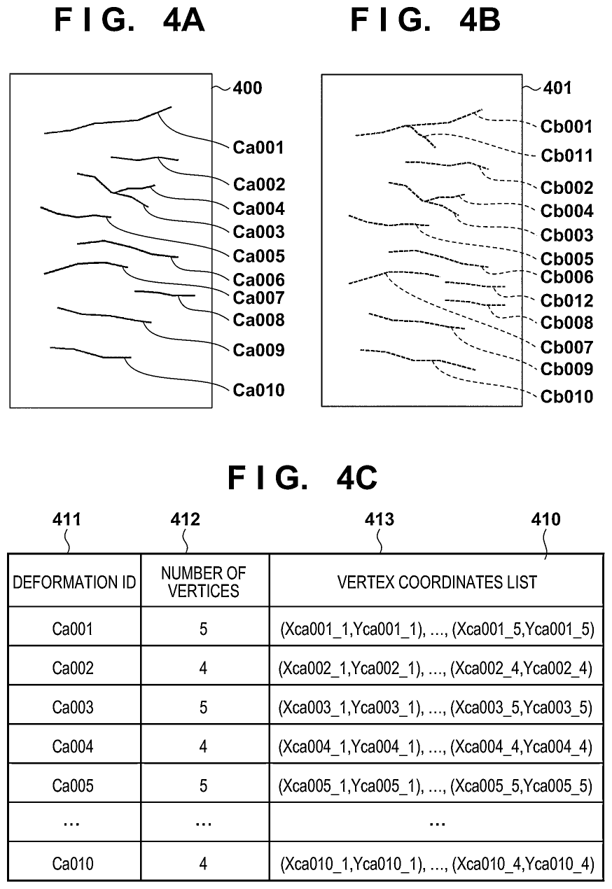

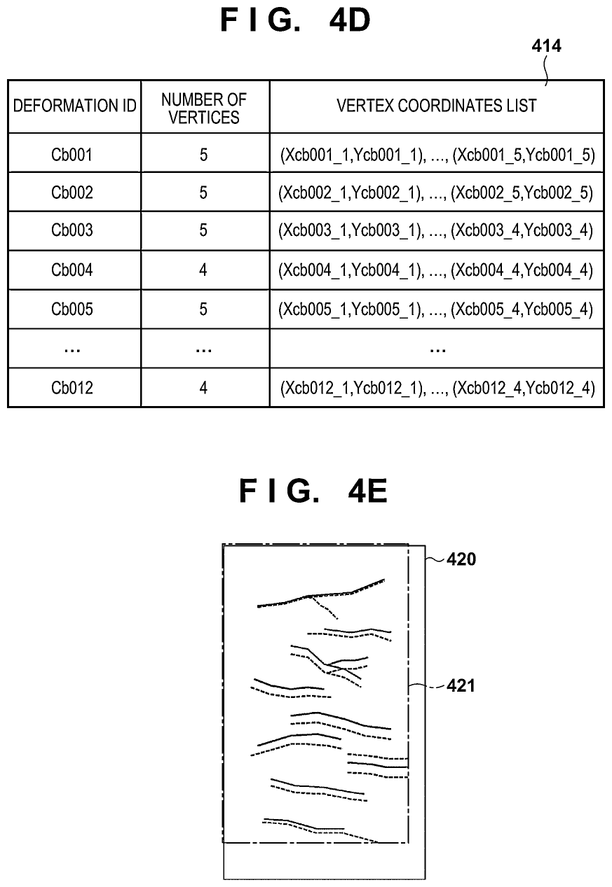

An obtaining unit 111 obtains position information indicating the position of the subject (target) from each one of two or more images captured of the target object. Here, the obtaining unit 111 obtains the first position information indicating the position of the target detected in the first image and the second position information indicating the position of the target detected in the second image. As the position information according to the present embodiment, a first polyline data group and a second polyline data group are obtained, for example. As illustrated in FIG. 4C described below, polyline data refers to data in which the shape of the subject (target) in the image is indicated by information of each vertex, and a polyline data group includes one or more pieces of polyline data. Here, the group of polyline data indicating the shape of the subject in the first image is defined as the first polyline data group, and the group of polyline data indicating the shape of the subject in the second image different from the first image is defined as the second polyline data group. The obtaining unit 111 can obtain the first polyline data group and the second polyline data group from the polyline data obtained via the I/F unit 107 and stored in the HDD 104, for example. Note that the obtaining unit 111 may obtain the first image and the second image and generate polyline data by detecting the subject in the images. Hereinafter, polyline data may be referred to as “polylines”. Also, hereinafter, when “vertices” are simply referred to, this means the vertices represented by the polyline data. Note that hereinafter, when “subject” is simply referred to, this means the “target” described above corresponding to the processing target for which the position information is obtained by the obtaining unit 111.

The information processing apparatus 100 according to the present embodiment estimates the position shift amount of the target on the basis of the obtained first position information and second position information. Here, the position shift amount of the target refers to the shift amount of the position of the polyline data included in the first polyline data group and the polyline data included in the second polyline data group, for example. The information processing apparatus 100 according to the present embodiment can evaluate the similarity between the polyline data included in the first polyline data group and the polyline data included in the second polyline data group. Hereinafter, the polyline data included in the first polyline data group is referred to as first polyline data, and the polyline data compared with the first polyline data for similarity is referred to as second polyline data.

The information processing apparatus 100 according to the present embodiment can generate a pattern image from both the first polyline data and the second polyline data and can perform a similarity evaluation via template matching using these pattern images. The configuration for performing similarity evaluation will be described below.

An image generation unit 112 can generate a pattern image for use in calculating the position shift amount of the first polyline data and the second polyline data from the polyline data. The processing executed by the image generation unit 112 will be described below.

A vector calculation unit 113 estimates the position shift amount of the target from the first position information and the second position information obtained by the obtaining unit 111. Here, for example, as the position shift amount, a shift vector calculated by the processing described below is used. The shift vector calculation processing will be described below.

A function generation unit 114 generates a function for transforming the coordinates in the coordinate system of the first polyline data into coordinates in the coordinate system of the second polyline data on the basis of the first polyline data group and the second polyline data group. For example, the first polyline data may include one or more pieces of polyline data, and the function described above may be generated on the basis of the one or more pieces of polyline data included in the first polyline data group and the corresponding polyline data included in the second polyline data group. Hereinafter, this function may be referred to simply as a “transformation function”. A function generation unit 114 according to the present embodiment generates the transformation function on the basis of the shift vector calculated by the vector calculation unit 113 for each polyline included in the first polyline data. The transformation function generation processing will be described below with reference to FIG. 9.

Here, the coordinate system of the first polyline data is a coordinate system in a target object image described below, and the coordinate system of the second polyline data is a coordinate system in a template image described below. These will be described below. However, as long as transformation can be performed in a similar manner, the coordinate system is not particularly limited. Corresponding different coordinates may be used, such as a coordinate system of vertices corresponding to the first image with coordinates indicating the vertices of the first polyline data.

A coordinate transformation unit 115 corrects at least one of the first position information and the second position information on the basis of the position shift amount estimated by the vector calculation unit 113. In the present embodiment, for example, the function generation unit 114 generates the transformation function on the basis of the shift vector calculated by the vector calculation unit 113, and the coordinate transformation unit 115 transforms the coordinates indicated by the first polyline data using the generated transformation function. Note that in the present embodiment described below, the coordinates indicated by the first polyline data are transformed into coordinates in the coordinate system of the second polyline data. However, the coordinates indicated by the second polyline data may be transformed into coordinates in the coordinate system of the first polyline data.

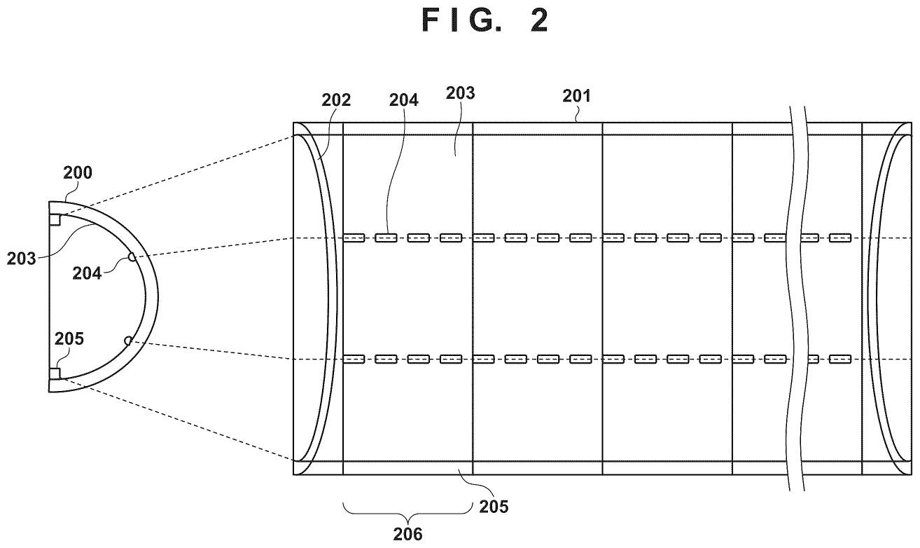

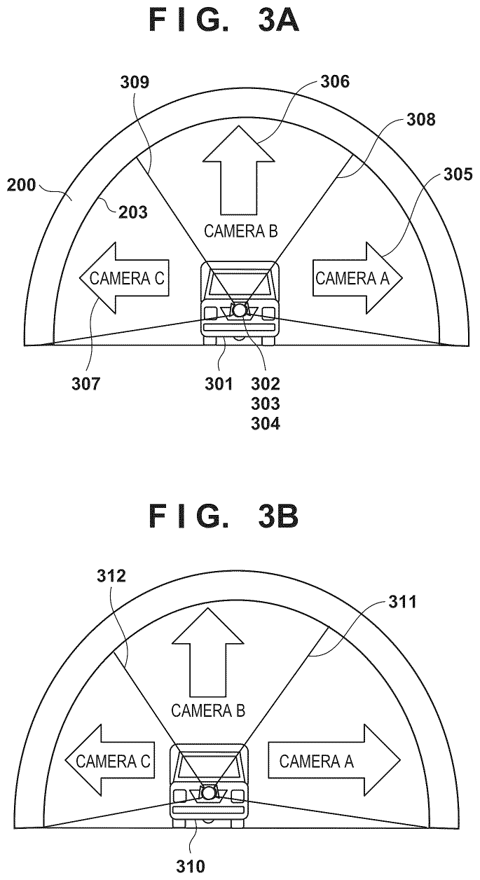

In the present embodiment, the first image and the second image are obtained as inspection images. Here, inspection images refer to two or more images captured of the subject corresponding to the comparison target that are used in the evaluation of the soundness of a construction, for example. Here, a method for obtaining the inspection images and the situation in which image position shift occurs during the obtaining will now be described with reference to FIGS. 2 and 3A and 3B.

FIG. 2 is a schematic view for explaining the relationship between a tunnel construction and captured inspection images, assuming a case in which the captured images of the inside of the tunnel are obtained as inspection images. In FIG. 2, a cross-sectional view 200 of the tunnel and a developed view 201 of the tunnel inner wall are illustrated. A tunnel lining surface 203, illumination 204 attached at or near the ceiling, and a curb 205 are also illustrated. Also, in the developed view 201, an opening portion 202 corresponding to the entry/exit of the tunnel and a span 206 corresponding to a unit for installing the concrete of the lining surface are illustrated. In the present embodiment, inspection (capture of inspection images) is repeatedly performed in the forward direction on a span basis.

FIGS. 3A and 3B are diagrams illustrating a state of capturing inspection images of a tunnel as seen from the tunnel cross section 200. To capture inspection images of the lining surface 203, the inspection target, a vehicle 301 attached with a line sensor camera as illustrated in FIG. 3A is driven along a path in the tunnel. Attached cameras 302 to 304 are line sensor cameras that capture images in different directions, and boundaries 308 and 309 indicate the boundaries of the field of views. FIG. 3B illustrates a state when the same tunnel is imaged at a different timing and though the cameras provided on a vehicle 310 are the same cameras 302 to 304, the driving position is different from that of the state illustrated in FIG. 3A.

In this case, the cameras 302 to 304 have the same field of view in both FIG. 3A and FIG. 3B, but because the imaging positions are different, even though the same subject is being captured, the position in the images will vary. Also, in FIGS. 3A and 3B, the position of the boundary of the field of view changes from 308 to 311 and from 309 to 312 due to the difference in the distance of the camera to the wall surface. Thus, in a case where an inspection image is made by combining the captured images of the three cameras after inspection imaging has ended, since the size of each image is adjusted, a shift in the position of the subject across inspection images is caused by a different in the field of view.

Deformations such as cracks and the like are extracted as subjects from the inspection image obtained in this manner, and polyline data is generated. As the extraction (subject detection) method, any known method can be used, such as setting a subject region in an image. For example, to detect a subject, the worker may use dedicated software and perform tracing manually, machine learning may be used to perform automatic detection via image recognition, or a combination thereof may be used. Note that in the examples described hereinafter, a crack in the image is detected as a subject, and the position and number of each vertex of the crack is generated as polyline data.

FIGS. 4A to 4E are diagrams for explaining polyline data according to the present embodiment generated after the detection of a crack in the tunnel lining surface. FIGS. 4A and 4B are schematic views of a polyline data group extracted from an inspection image obtained at different timings (two time periods) for the same span in the tunnel. The developed view 201 of FIG. 2 corresponds to one span. In a polyline data group 400 of FIG. 4A, polyline data corresponding to ten cracks from Ca001 to Ca010 is represented as a straight line group. In FIG. 4B illustrating polylines 401 obtained at a later timing (in this example, a few years later), one or more of Cb001 to Cb010 corresponding to the ten cracks in FIG. 4A have become longer, their deformation progressing. Also, two cracks Cb011 and Cb012 have newly appeared. Note that in FIG. 4B, the polylines are illustrated as broken lines. This is to distinguish them from the cracks of FIG. 4A, and this does not mean that the polyline data is intermittent. The polyline data illustrated in FIGS. 4A and 4B is stored as a file in the HDD 104.

FIG. 4C is a table illustrating an example of polyline data corresponding to FIG. 4A. FIG. 4D is a table illustrating an example of polyline data corresponding to FIG. 4B. FIG. 4A indicates three fields: Deformation ID 411 for identifying each crack, Vertex number 412 indicating the number of vertices included in the crack, and Vertex coordinates list 413 indicating the coordinates of each vertex. Vertex coordinates list 413 is a list of the coordinate values of each vertex, using the top left of the inspection image of one span as the origin point, the horizontal direction as the X-axis, and the vertical direction as the Y-axis. 414 of FIG. 4D is a vertex coordinates list 414 corresponding to FIG. 4B, and the origin point of the vertex coordinates is the same as in 410.

420 of FIG. 4E is the polyline data of FIGS. 4A and 4B overlapped with the origin point aligned and illustrates the difference in the polyline data of the two time periods. The difference in the polyline data of the two time periods includes the results of the progression of deformation due to aging and position shift caused by different imaging states as illustrated in FIGS. 3A and 3B. A rectangular region 421 is a bounding box including the origin point and all of the polyline data of the two time periods. This will be referenced again in the following processing description.

In the present embodiment, of the first image and the second image, which are inspection images, the coordinates of the polyline data included in the first image are transformed. In other words, to perform inspection, the coordinates of the polyline data included in the first image are transformed to the coordinates in the polyline data coordinate system included in the second image using the polyline data included in the second image as a reference (reference image). Here, the second image is an image captured at a more recent timing than the first image, for example. However, the selection of the image to use as a reference (not to use for coordinate transformation) is not limited to this. For example, in another embodiment, the user may select, from the two images, the image to perform polyline data coordinate transformation on (image for transformation). For example, the obtaining unit 111 may prompt the operator to designate which of the file names of the polyline data of the two time periods to compare is to be used as the image for transformation via a command prompt implemented by the display unit 105 and the operation unit 106. Note that for the designation, the obtaining unit 111 may present a list of files as a GUI and accept a selection from a user.

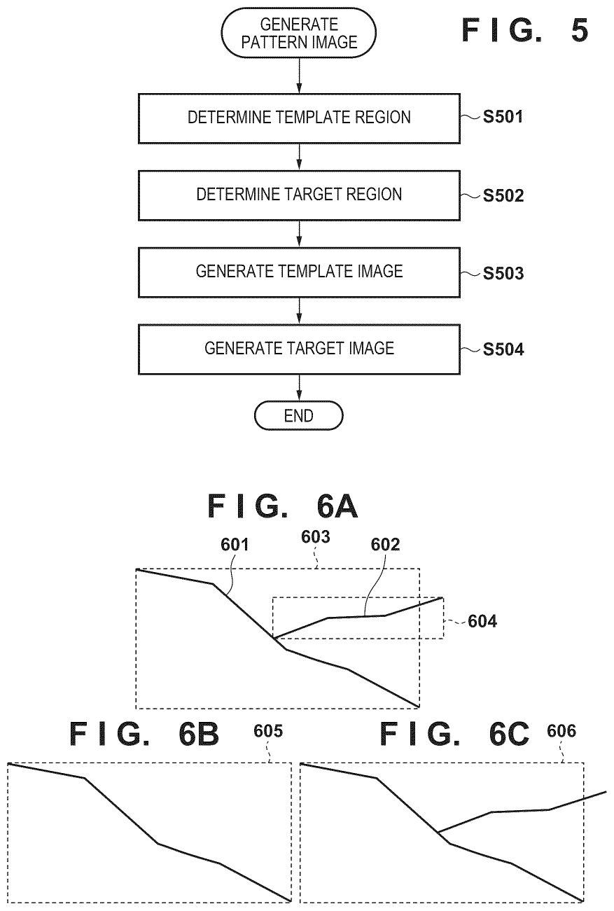

FIG. 5 is a flowchart illustrating an example of the pattern image generation processing of the image generation unit 112. At the image generation unit 112, a pattern image of a template used in template matching executed by the vector calculation unit 113 and a target object pattern image are generated. Here, of the two pieces of polyline data obtained by the obtaining unit 111, the first polyline data included in the first polyline data group is set as the template, and the second polyline data included in the second polyline data group is set as the target object, but either may be set as the template. In a case where the region or the number of vertices in the two pieces of polyline data vary, the smaller of the two is used as the template and the larger of the two is used as the target object, allowing for unnecessary searching when there is not matching partner to be suppressed. In the case of inspecting deformation in a construction, normally, as illustrated in FIGS. 4A to 4E, the number of vertices included in the polyline data tends to increase over time. Thus, the polyline data group 400 obtained at an older time period may be used as the template and the polylines 401 obtained at a newer time period may be used as the target object.

In step S501, the image generation unit 112 determines a template region. In the present embodiment, as described above, the bounding boxes of the polyline data included in the polyline data group 400 of the older imaging time period is used as the template. Note that in the template, drawing line width of the polyline data described below relating to step S503 may be added. FIG. 6A is a schematic view illustrating an example of a template region. In FIG. 6A, two polylines 601 and 602 are illustrated, and rectangular regions 603 and 604 representing template regions are indicated with broken lines.

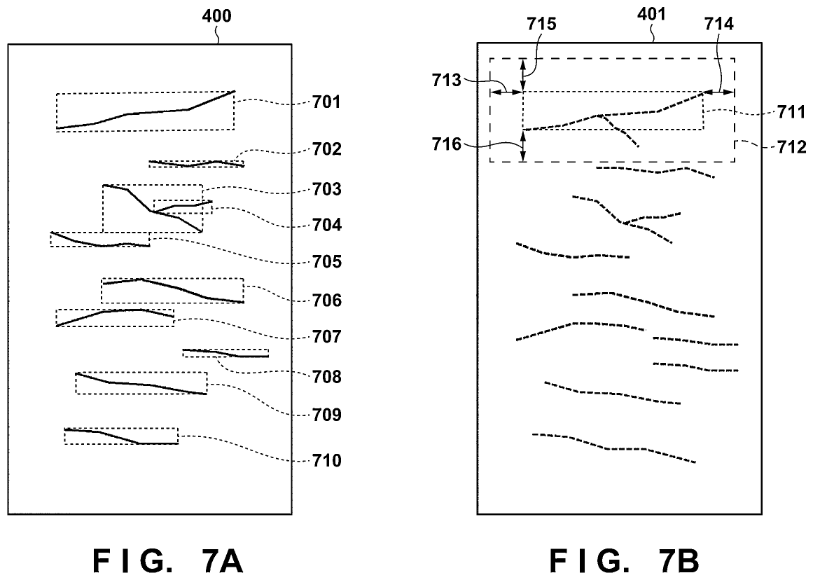

In step S502, the image generation unit 112 determines a template and a target region for matching. FIG. 7 is a schematic view for explaining the target region determining processing. FIGS. 7A and 7B illustrate polyline data obtained in two different time periods. In FIG. 7A, templates 701 to 710 determined in step S501 are indicated by broken line rectangles. A template 711 of FIG. 7B corresponds to the template 701 at the same coordinates. A target area 712 includes target widths 713 to 716 added around the template 711 to the up, down, left, and right directions. The target width 713 to 716 can be set to a desired value taking into account shifts in the polylines in the two time periods or can all be the same width. The target widths 713 and 714 in the horizontal direction or the target widths 713 and 716 can each have the same width or they may all have different widths. Also, the target width for each polyline of the templates 701 to 710 may be different or they may all be the same width.

In step S503, the image generation unit 112 generates a template image. As illustrated in FIG. 6B, the template image may include only the polyline drawn in the region determined in step S501, or as illustrated in FIG. 6C, all of the polyline on the side used as a template may be drawn and the template region may be obtained via cropping. In the latter case, a portion of another polyline 602 included in the template region may be included in the template.

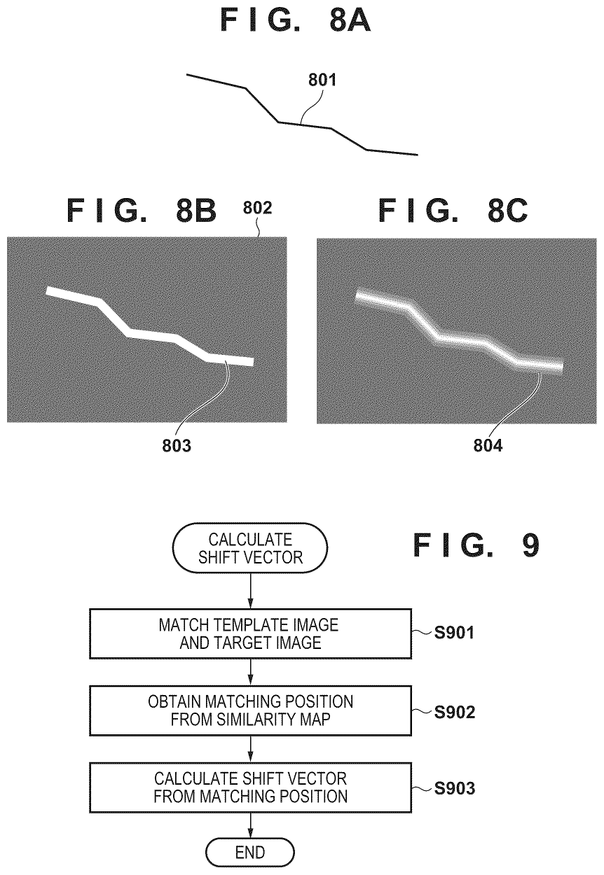

FIGS. 8A to 8C are diagrams for explaining polyline drawing. The image generation unit 112 generates an image with a white polyline 803 with a constant line width drawn against a black background 802, as illustrated in FIG. 8B, as a template based on a polyline 801 illustrated in FIG. 8A. Alternatively, the image generation unit 112 may generate an image with a drawn polyline 804 and a pixel value gradient added in the line width direction centered on the polyline 804 as illustrated in FIG. 8C. In a case where a pixel value gradient is added as with the polyline 804, in template matching, a certain level of balance can be expected between the tolerance with respect to the shift amount and the matching accuracy.

In step S504, the image generation unit 112 generates a target object image. The image generation unit 112 draws all of the polylines 401 obtained in a newer time period as the target object in a similar manner to the template of step S503 and crops the target object region determined in step S502 to obtain a target object image. When the polyline 401 is drawn, around the rectangular region 421 of FIG. 4E, a background color region is added in the up, down, left, and right directions using the target widths 713 to 716, and a target region corresponding to the template near the periphery is ensured. Note that in the template image and the target object image with the drawn polylines, the polylines are a white color and the background color is black. However, the colors are not particularly limited and can be set to a desired color according to a condition.

FIG. 9 is a flowchart for explaining the shift vector calculation processing of the vector calculation unit 113. The shift vector according to the present embodiment refers to the shift amount between the first polyline data and the second polyline data as described above. Here, the shift vector is, with respect to the polylines of the timing of the image for transformation designated by the obtaining unit 111, a shift in the position of the polylines corresponding to a different timing. The shift vector varies by position in the coordinate space due to the occurrence of position shift described above.

In step S901, the vector calculation unit 113 executes template matching using the template image and the target object image generated by the image generation unit 112. FIG. 10A is a diagram for explaining template matching executed according to the present embodiment. In a target object image 1002 for a template image 1001, polylines 1003 and 1004 are drawn. The polyline of the target object image 1002 in FIG. 10A is a broken line. However, the polyline is not drawn in the pattern image as a broken line, and solid lines and broken lines are used here to distinguish between polylines of the templates merely to facilitate the explanation.

The vector calculation unit 113 calculates a similarity score for each position of the template image by sliding the template image 1001 from a position 1005 to a position 1006 in the vertical and horizontal (right direction and down direction) within the target object image 1002. The similarity score calculated here is the similarity between the first polyline data and the second polyline data at each position of the template image. As the score calculation method, any method may be used including typically methods such as sum of squared difference (SSD) and normalized cross correlation (NCC), and the method is not particularly limited. The size (width, height) of the template image 1001 and the target object image 1002 are defined as (w, h) and (W, H), respectively, and the result of matching is a two-dimensional map of the size (W-w, H-h). For example, in a case where matching using NCC is performed on the template image 1001 and the target object image 1002, the matching result is a cross section of a center of the horizontal and the vertical corresponding to the maps 1007 and 1008.

In step S902, the vector calculation unit 113 obtains the position where the template image 1001 matches the target object image 1002 on the basis of the score map. The matching position is the position on the map where the similarity in the map calculated in step S901 is the maximum (in the case of SSD, the minimum score, in the case of NCC, is maximum score).

FIG. 10B is a diagram for explaining the matching position output in step S902. FIG. 10B illustrates, in a case where a template 1009 is moved within a target object image 1010 including a polyline 1011, the relative position of both (position of the template image with respect to the target object image) in a map area 1012. Here, the matching score (similarity) is calculated as the score at a center position (x, y) of the area 1012 with the origin point in the upper left, with respect to area 1012 of the map. In the example of FIG. 10B, the coordinates of a position 1013 where the template image overlaps the target object image unchanged without being moved is defined as (x₀, y₀), and the coordinates of a position 1015 where the template 1009 is moved to a region 1014 resulting in the maximum similarity is defined as (xₘₐₓ, yₘₐₓ). Note that in a case where a plurality of target object polylines run side by side, there is a possibility that the similarity with the non-matching polyline is the maximum. However, such noise at the time of matching is handled via a later-stage processing.

In step S903, the vector calculation unit 113 calculates the shift vector between the polylines of the two time periods from the matching position obtained in step S902. The shift vector calculation processing according to the present embodiment will be described below with reference to FIGS. 11A and 11B. FIG. 11A illustrates matching that is the same as in the example of FIG. 10B with the template 1009 being moved to 1014. Here, in the coordinate system of the span images of FIGS. 4A to 4E, the coordinates of a position 1100 of the center of the template 1009 before movement is defined as (x₁, y₁), and the coordinates of a position 1101 of the center of the template 1009 at the time of matching is defined as (x₂, y₂). When the polyline of the image for transformation designated by the obtaining unit 111 is the polyline of the time period of when used as a target object image (illustrated by a grey broken line in FIGS. 11A and 11B), the shift vector for the position 1101 corresponds to a vector 1102 extending from the position 1101 to the position 1100. In other words, the shift vector in FIG. 11A corresponds to (x₁-x₂, y₁-y₂). Also, as illustrated in FIG. 11B, the shift vector at the position 1100 is indicated by a vector 1103 in a case where the image for transformation designated by the obtaining unit 111 is a polyline of the timing when used as a template image (illustrated by a black solid line in FIGS. 11A and 11B). In other words, the shift vector in FIG. 11B corresponds to (x₂-x₁, y₂-y₁). In this manner, the vector calculation unit 113 according to the present embodiment can calculate, as the shift vector, the vector between the position of the template before template matching and the position of the template with the maximum similarity.

The coordinates of each vertex of the first polyline data according to the present embodiment are shifted by an amount corresponding to the same shift vector (for example, (x₁-x₂, y₁-y₂) described above) to transform them to the coordinates in the coordinate system of the second polyline data. However, this is not limited to the subject simply translating in the image between the first image and the second image, and there is a possibility that appropriate coordinates cannot be obtained via a simple translation using the shift vector. From this perspective, the vector calculation unit 113 according to the present embodiment may calculate a shift vector for each piece of polyline data included in the first polyline data group. In this case, the function generation unit 114 can generate a transformation function on the basis of each shift vector calculated by the vector calculation unit 113.

In this manner, by calculating a plurality of shift vectors and estimating a transformation function from the plurality of shift vectors, a transformation function that can be applied to each vertex to transform the coordinate system of the polylines can be obtained. Thus, for each vertex of each piece of polyline data included in the first polyline data group, the coordinates can be transformed via transformation using a transformation function and inspection can be performed.

According to the present embodiment, using a transformation function f, as in the following Formula (1), a shift vector V is output indicating a vector from input coordinates U to coordinates (transformation coordinates) after transformation to the coordinate system of the second polyline data.

$$V = f ( U ) \qquad Formula ( 1 )$$

Note that the vector calculation unit 113 calculates the shift vector V for the polyline data. Here, for example, the vector calculation unit 113 may calculate the shift vector V for one of the pieces of polyline data included in the first polyline data group, may calculate the shift vector V for one or more pieces, or may calculate the shift vector V for all of the pieces. Next, the function generation unit 114 models the transformation function for each one of an x component Vₓ and a y component V_{y} of the shift vector V using x and y as independent variables and estimates each constant (A to H in this example) to generate a transformation function.

$${V}_{x} = {f}_{x} ( x , y ) = A x + B y + C \qquad Formula ( 2 )$$

$${V}_{y} = {f}_{y} ( x , y ) = D {x}^{2} + E {y}^{2} + F x + G y + H$$

Here, the vector calculation unit 113 calculates the shift vector V for each piece of polyline data, for example, Ca001 to Ca010 illustrated in FIGS. 4A to 4E, and the function generation unit 114 can calculate the constant of Formula (2) on the basis of the calculated shift vector V.

Note that the transformation function for obtaining the shift vector (Vₓ, V_{y}) from the coordinates (x, y) in the coordinate system of the first image are not limited to that indicated in Formula (2), and another model such as an affine transformation may be used taking into account the cause of the shift, the tendency of the shift, or the like. For example, in the case of using an inspection image of a tunnel lining surface, it is expected that there will be little change in the shift in the driving direction in a short section of one span, that is, the X-axis direction of FIGS. 4A to 4E. Thus, by only using an independent variable y, the constants to be estimated may be reduced.

FIG. 12 is a flowchart illustrating an example of the transformation function generating processing executed by the function generation unit 114. In step S1201, the function generation unit 114 sets the coordinates of the first polyline data (the position of the center of the template in this example) and the shift vector calculated by the vector calculation unit 113 as the actual measurement values of the independent variable and the dependent variable.

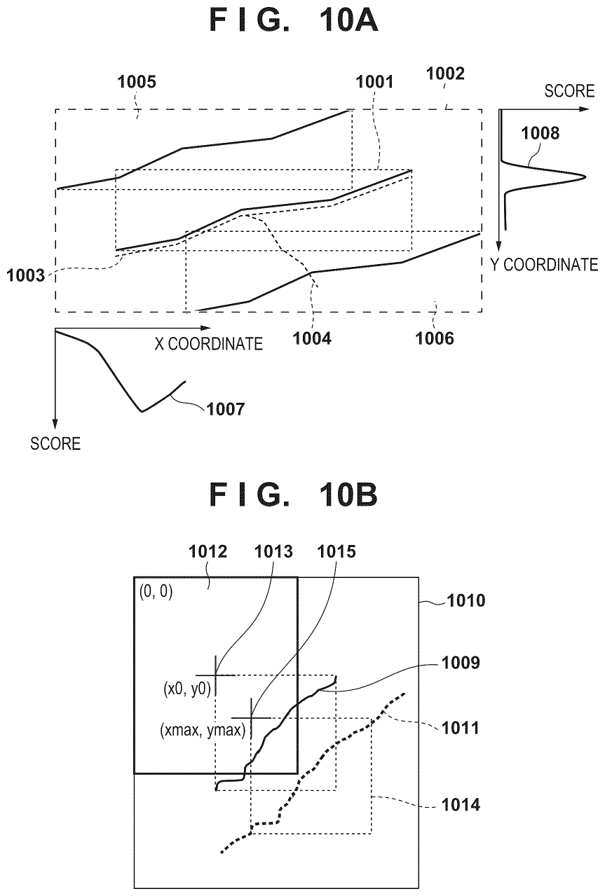

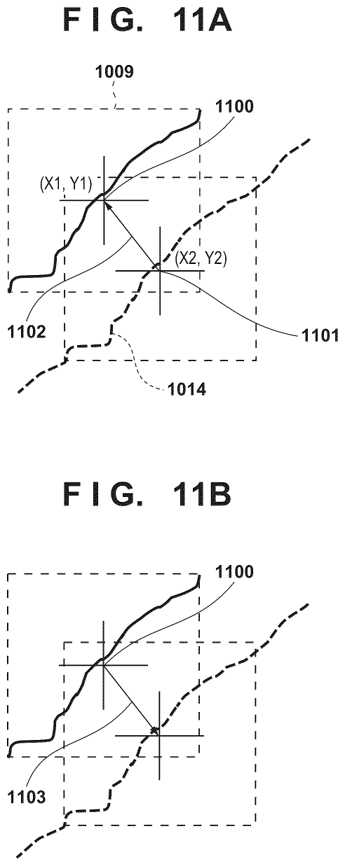

FIG. 13A is a diagram illustrating candidates determined in step S1201 using the shift vectors calculated using the polyline groups of the two time periods illustrated in FIGS. 4A to 4E as the processing targets. In 1300, the actual measurement values described above are plotted as three-dimensional coordinates (x, y, V_{y}) using the polyline data coordinates (x, y) and the y component V_{y} of the shift vector transformed using these coordinates. An X-axis 1301 represents the x coordinates in the coordinate system of the first image, a Y-axis 1302 represents the y coordinates in the same coordinate system, and a Z-axis 1303 represents the y component V_{y} of the transformation vector. The units used are all pixel numbers. In the portion enclosed by a broken line 1304, the actual measurement values (x, y, V_{y}) corresponding to the templates 701 to 710 of FIG. 7A are plotted. A diagram with the three-dimensional coordinates (x, y, Vₓ) plotted can also be generated in a similar manner, but this description will be omitted herein.

In step S1202, the function generation unit 114 excludes, of those set as actual measurement values in step S1201, those corresponding to noise. The function generation unit 114 can exclude, of the vectors (Vₓ, V_{y}), those corresponding to noise via a known processing for excluding outliers using typical statistical processing, such as excluding values with a difference from the overall average that is greater than a constant multiple of the standard deviation, for one or both of the scalar values of each component. Note that in a case where a position shift is caused by a difference in the imaging position between the first image and the second image, the tendency of the transformation via the transformation function changes depending on the position. Thus, instead of the overall actual measurement value, the region illustrated in FIGS. 4A to 4E is divided into partial regions, and the outliers for each partial region may be obtained and excluded.

In step S1203, the function generation unit 114 may perform transformation function correction on the basis of the number of actual measurement values remaining after excluding the outliers. The model function of Formula (2) includes eight constants from A to H. However, if there are few actual measurement values, correct calculation may be impossible. From this perspective, in step S1202, the function generation unit 114 can correct the model function to reduce the number of constants that need to be calculated using the number of actual measurement values remaining that have not been excluded. For example, in a case where the number of remaining actual measurement values is less than a predetermined threshold (for example, the number of constants of the model function), the function generation unit 114 can correct the model function by setting one or both of the constants of the square component of f_{y}(x, y) to 0, reducing the degree of the model function, or the like.

In step S1204, the function generation unit 114 calculates the weighting of each actual measurement value to be used in the transformation function generation processing of step S1205. The function generation unit 114 may calculate the weighting on the basis of the shape of the template, for example. In this case, the function generation unit 114 may calculate the weighting from the shape of the template on the basis of the size in the direction orthogonal to the X component and Y component of the shift vector. For example, the function generation unit 114 can set the value of the height of the template image as the weighting for fₓ(x, y) and set the value of the width of the template image as the weighting for f_{y}(x, y). Here, the function generation unit 114 may set the value of the height and the value of the width of the template image unchanged as the weighting or may set a value obtained by performing a predetermined operation, such as multiplication by a predetermined coefficient or the like, on each as the weighting. Also, the function generation unit 114 may calculate the weighting on the basis of the similarity at the time of matching. In this case, the function generation unit 114 can set the weighting so that the value increases for the weighting of a target object image with high matching similarity.

In step S1205, the function generation unit 114 adds the weighting calculated in step S1204 to the actual measurement value with the outliers excluded in step S1202 and calculates the constants of the model function corrected in step S1203. Here, the function generation unit 114 can output a model function via the weighted least squares method, for example. For the model function generation processing, any known technique for outputting a model function from a similar input can be used, and a detailed description thereof will be omitted.

In step S1206, the function generation unit 114 can remove a polyline determined to be an outlier on the basis of the transformation coordinates and actual measurement values output using the transformation function generated in step S1205. For example, the function generation unit 114 can set a polyline with a difference between the transformation coordinates and the actual measurement value of 3.0 times or more of the standard deviation as an outlier. Note that the outlier obtaining method is not limited thereto, and another known method, such as using statistical analysis, may be used.

In step S1207, the function generation unit 114 determines whether or not the number of actual measurement values (number of polylines) remaining after the removal of outliers in step S1206 is equal to or less than a threshold or whether or not outlier removal has been performed in step S1206. This threshold is the number of actual measurement values needed to obtain the constant of the model function in step S1205 and is the number of constants, for example. If “no” is determined in step S1207, the processing returns to step S1205. If “yes” is determined, the processing of FIG. 12 ends.

FIG. 13B illustrates a three-dimensional graph of the actual measurement values illustrated in FIG. 13A and the output of the transformation function generated via the processing illustrated in FIG. 12 on the basis of the actual measurement values. A mesh-like curved plane 1305 indicates the distribution of Y components V_{y} of shift vectors, which are the output of the transformation function. Note that the distribution (not illustrated) of X components Vₓ of the shift vectors corresponds to a flat plane from the degree of Formula (2).

The coordinate transformation unit 115 transforms the coordinates of each vertex of the polyline of the timing of the image for transformation designated in obtaining unit 111 using the transformation function generated by the function generation unit 114 and generates the transformation coordinates. Formula (3) indicates the relationship between the pre-transformation coordinates (x, y) and the post-transformation coordinates (x′, y′).

$$[ \begin{matrix}{x}^{′} \\ {y}^{′}\end{matrix} ] = [ \begin{matrix}x \\ y\end{matrix} ] + [ \begin{matrix}{f}_{x} ( x , y ) \\ {f}_{y} ( x , y )\end{matrix} ] \qquad Formula ( 3 )$$

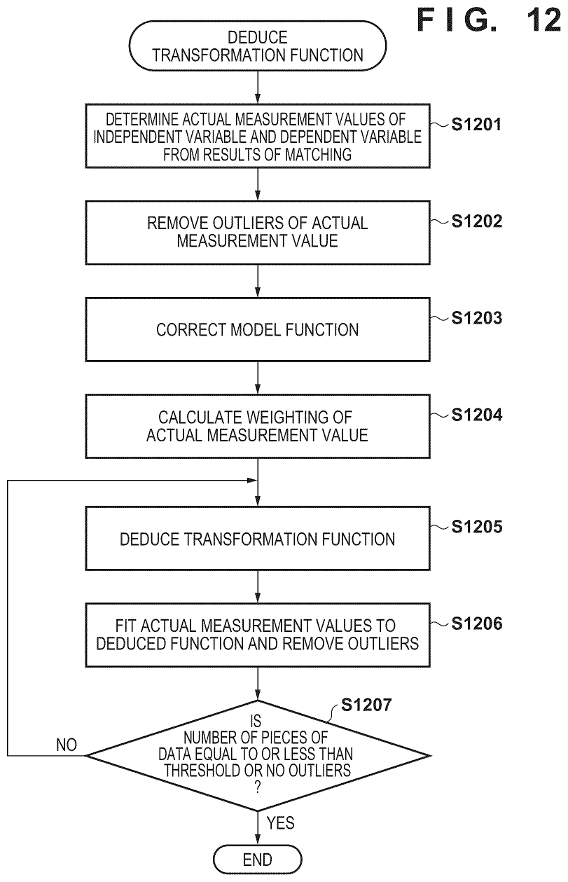

FIG. 14 illustrates the result of coordinate transformation by the coordinate transformation unit 115, and 1400 illustrates the polylines of FIG. 4A indicated by solid lines overlapped with polylines indicated by dot-dash lines obtained via coordinate transformation of the polylines of FIG. 4B.

According to this configuration, on the basis of the polylines of a plurality of images of different imaging timings, a function for transforming the coordinates in the coordinate system of the first image into the coordinate system of the second image can be generated, and the coordinates of the vertices of one polyline can be transformed on the basis of this function. In particular, a template image and a target object image are generated, a shift vector of each polyline is calculated using template matching, and coordinate transformation of each polyline is performed using the transformation function estimated from the shift vectors. Accordingly, the position shift of the subject produced by a difference in the imaging state of the images used in polyline extraction can be corrected with only polyline data and not using the captured images. This has the effect of reducing the costs needed for correcting the position shift of the subject in the images.

This also has the effects of suppressing unnecessary matching processing and improving the speed of processing and the accuracy of correction by using, of the two pieces of polyline data, the one with a smaller polyline region or few vertices as the template. Another effect includes improving the shift correction accuracy when drawing a polyline to generate a pattern image by adding a gradient of pixel values in the line width direction.

Another effect includes reducing the effects of mistakes in the template matching caused by polylines that run side by side and the like by removing the shift vectors corresponding to outliers via the processing of steps S1202 and S1206 and the like. Another effect includes reducing the effects of tracing mistakes made by a worker and polyline data errors caused by a detection error in image recognition by machine learning in the extraction of polylines from the image by adding such outlier removal.

Another effect includes being able to handle cases of a small amount of polyline data corresponding to the template by correcting the model function to reduce the constants to estimate via the processing of step S1203 and the like. Another effect includes improving the accuracy of transformation function generation by adding weighting to the actual measurement values in step S1203 of FIG. 12. Another effect includes prioritizing the shift correction of polylines in a broad area with high importance by adding weighting based on the size of the template running orthogonal to the shift component.

### First Modified Example

In the first embodiment, in step S501 of the pattern image generation processing illustrated in FIG. 5, the template region is a bounding box including each of the polylines. In the present modified example, the number of templates is increased by dividing the template region into smaller partial regions.

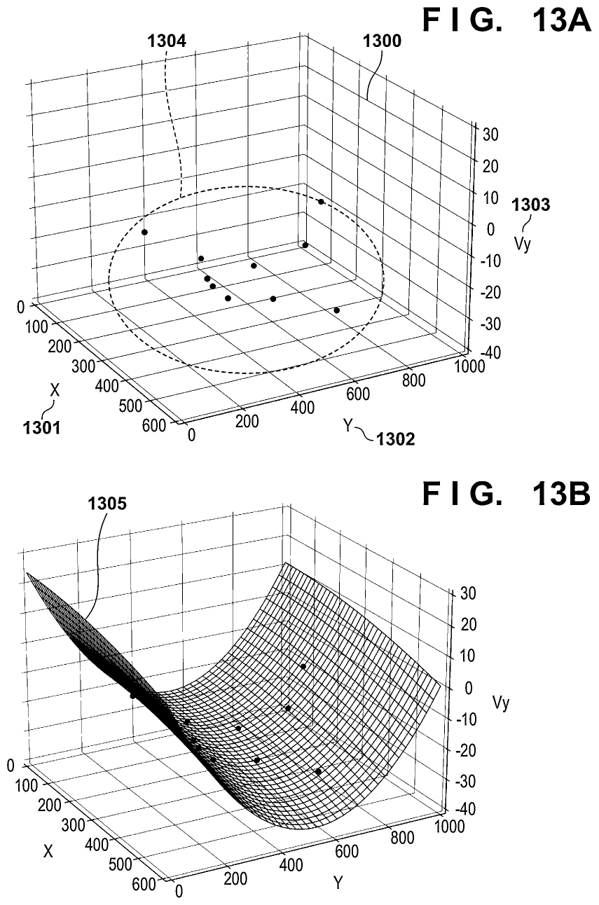

FIG. 15 is diagram for explaining an example of polyline data of smaller template regions and an increased number of templates. A rectangular region 1500 is a bounding box region including all of the polyline data of the two time periods of FIG. 4E and is a polyline drawn region. This region is divided into grid-like partial regions vertically and horizontally as indicated by broken lines, and of these, the partial regions in which a polyline is superimposed, such as region 1501 indicated with hatching, are used as templates. In FIG. 15, the rectangles with a hatched background are used as templates, but this does not mean that the hatching is drawn as the background.

Also, each of the polylines may be divided in a certain size, and a bounding box of each divided polyline may be used as a template. For example, when the longest side of bounding box of the polyline or the length of the diagonal line is defined as 1 and a reference length is defined as L, an integer n satisfying the following Formula (4) is obtained, and the polyline is divided into n parts so that the number of vertices is roughly the same in each part.

$$L n \leq 1 \leq L ( n + 1 ) \qquad Formula ( 4 )$$

According to this processing, by reducing the size of the template region, the effects of improving the accuracy of each shift vector, increasing the number of effective shift vectors, and improving the accuracy of the transformation function generation are achieved. Another effect includes reducing the size of the template region to reduce the effects of the transformation of the polyline shape on the matching due to the difference in the shift depending on position.

### Second Modified Example

In the case of a polyline of a crack extracted from an inspection image of a tunnel lining surface, for example, it is plausible that there will be little variation in the camera movement path and speed, a main cause of position shift, across adjacent spans. Thus, the tendency of the position shift of adjacent spans is roughly the same, and the same transformation function can be expected to be able to be used for the vertices of that span.

In other words, the function generation unit 114 according to the present modified example determines whether or not the imaging conditions are similar across polyline data and executes transformation of the coordinates using a common transformation function for polyline data with a similar imaging condition. In this case, the function generation unit 114, via processing similar to that in the first embodiment, can apply the transformation function generated for one piece of polyline data to a piece of polyline data with imaging conditions that are similar to the first piece of polyline data. Also, for example, the function generation unit 114 may generate, from all of the polyline data with similar imaging conditions, a transformation function to use for this polyline data.

The present modified example is different from the first embodiment in that, when generating the transformation function at the function generation unit 114, shift vectors calculated from polylines of a plurality of adjacent span are collectively used, as opposed to that of just one span. The collective area of the shift vectors can be divided at a certain span number or so that the length of the connected spans corresponds to a certain distance, and the shift vectors of the vertices of the polyline of one division can be handled collectively. Also, the function generation unit 114 may collectively handle all of the spans in the tunnel as one span. Alternatively, when the collective number of spans is defined as n, the function generation unit 114 collectively executes transformation function generation processing relating to the i-th (1≤i≤n) span on the polyline of each span sliding from the i-th span to the i+n−1-th span.

In the transformation function generation processing, the function generation unit 114 combines the collective area of spans and executes each process using a coordinate system with the upper left as the origin point. In this case, the function generation unit 114 sets a value obtained by adding the total span width on the left side to the x obtained in step S903 as an independent variable of the X-axis direction in step S1201.

Note that in the example described here, processing is executed for a consecutive span in tunnel inspection. However, application of the present modified example is not limited to such examples. For example, this can be applied to a case where an inspection image relating to the slab of a bridge of a wall surface of a building is the processing target, the image capture settings such as distance from target, angle, lens focal length, and the like are constant and images are consecutively captured over a plurality of inspection units.

According to this processing, by collectively using the shift vectors obtained per consecutive unit of inspection in generating a transformation function, compared to using only a single unit of inspection in the generating, the accuracy of the transformation function generation is improved.

### Third Modified Example

In the first embodiment, in the shift vector calculation processing illustrated in FIG. 9, the shift vectors are calculated using the coordinates of when the matching similarity is the maximum. However, depending on the arrangement state of the polylines of the two time periods, the peak of the matching similarity may not be clearly indicated or there may be a plurality of similarity peaks. From this perspective, the vector calculation unit 113 according to the present modified example takes into account the matching similarity value as well as the similarity distribution state when calculating the shift vectors.

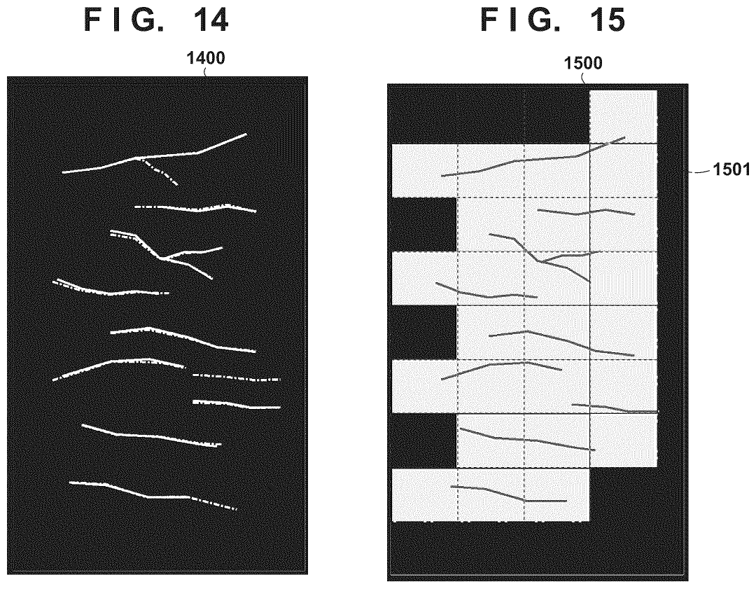

FIG. 16 is a diagram for explaining the polylines when there are a plurality with matching similarity. In 1600, polyline groups of two time periods are superimposed. The polylines of an older timing are indicated with a solid line, and the polylines of a newer timing are indicated with a broken line. The polylines of a newer timing illustrated in a partial region 1601 in 1600 include a polyline corresponding to the polyline of an older timing and new polyline running side by side. Also, in FIG. 16, a target region 1602 and a template 1603 relating to the partial region 1601 are illustrated in an enlarged manner. Using these, a cross section taken along the Y-axis direction at the left and right center position of the two-dimensional map of the matching score calculated by the vector calculation unit 113 is illustrated as a graph 1604.

As illustrated in the graph 1604, in the example of FIG. 16, the template 1603 matches both of the two polylines above and below it in the target region 1602. This causes two peaks in the score. In such a case, simply using the coordinates with the highest similarity (the relationship between the high/low score and the similarity according to the matching method) as the matching position has the possibility of producing an incorrect result.

Thus, in a case where there are a plurality of peaks in the similarity distribution, for each of the peaks, the vector calculation unit 113 according to the present modified example calculates the shift vector using similarity processing to that described in the first embodiment and executes the subsequent processing as is. Note that here, a region where the similarity is greater than a certain value is set as a matching position (position corresponding to a peak). However, for example, a region with a similarity in a predetermined range from the calculated maximum similarity may be set as a position corresponding to a peak, or this can be set according to a user-desired condition.

It is plausible that any one of the shift vectors calculated from the plurality of peaks corresponds to noise. However, it is expected that these are removed as outliers using the processing to remove outliers of steps S1202, S1206, or the like. Note that the vector calculation unit 113 may calculate the shift vector only in the case of a single peak without calculating the shift vector, considering both peaks to be noise in the case of a plurality of peaks. Also, the vector calculation unit 113 may calculate the shift vector in a case where there is no clear peak.

According to this processing, by performing shift vector calculation taking into account the matching similarity distribution, noise caused by mismatching can be reduced. In particular, in a case where polylines run side by side, using processing taking into account a plurality of peaks can have the effect of improving the accuracy of position shift correction.

Note that in the present embodiment described above, each process is executed using a construction as the imaging target object and deformation as the processing target. However, no such limitation is intended, and it is sufficient that similar processing can be executed from image detection results.

### Second Embodiment

An information processing apparatus 1700 according to the second embodiment can execute processing similar to that of the information processing apparatus 100 according to the first embodiment. Also, the information processing apparatus 1700 according to the present embodiment is provided with a function for setting various types of parameters needed for the coordinate transformation processing and a function for displaying the position shift correction results and provides an interactive GUI for the operator. The hardware configuration of the information processing apparatus 1700 is similar to that illustrated in FIG. 1A of the first embodiment.

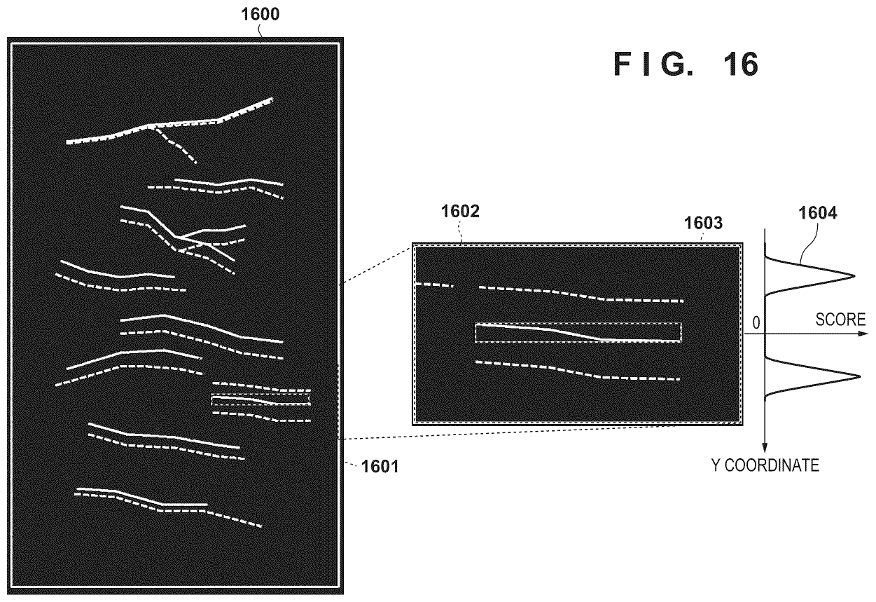

FIG. 17 is an example of a block diagram illustrating the functional configuration of the information processing apparatus 1700 according to the present embodiment. The functional units are implemented by a program stored in the ROM 102 being deployed on the RAM 103 by the CPU 101 and the processing according to each flowchart described below being executed. The information processing apparatus 1700 according to the present embodiment includes functional units similar to those illustrated in FIG. 1B of the first embodiment except that a control unit 1701 and a display control unit 1702 are additionally included, and thus redundant description will be omitted. The control unit 1701 accepts an operation on the GUI element displayed on the display unit 105 via the operation unit 106. The display control unit 1702 displays the polylines of the designated two time periods and the polylines after position shift correction on the display unit 105.

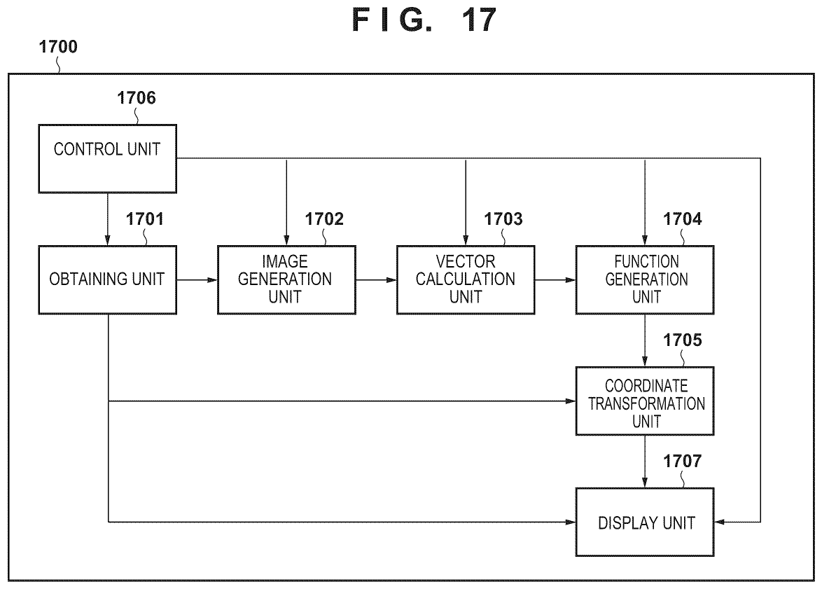

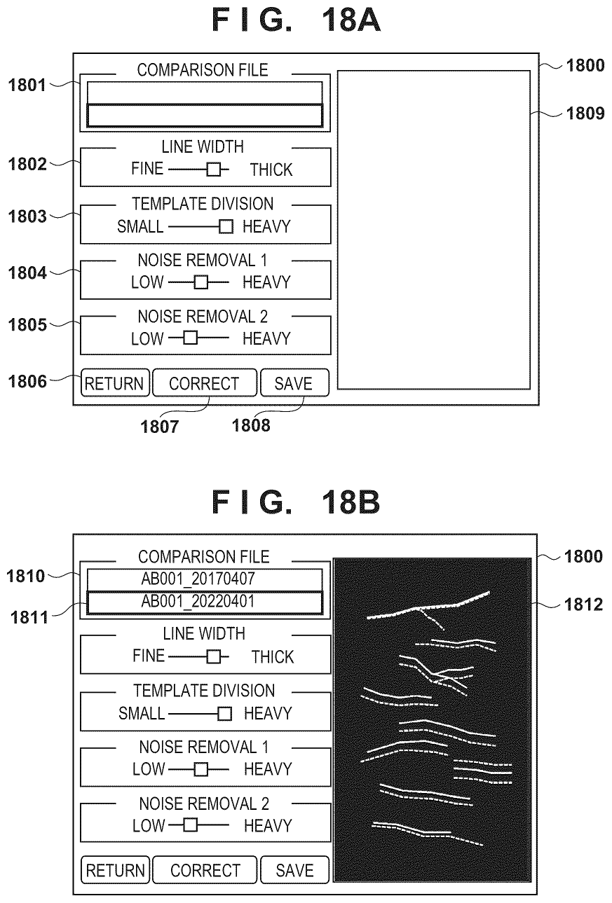

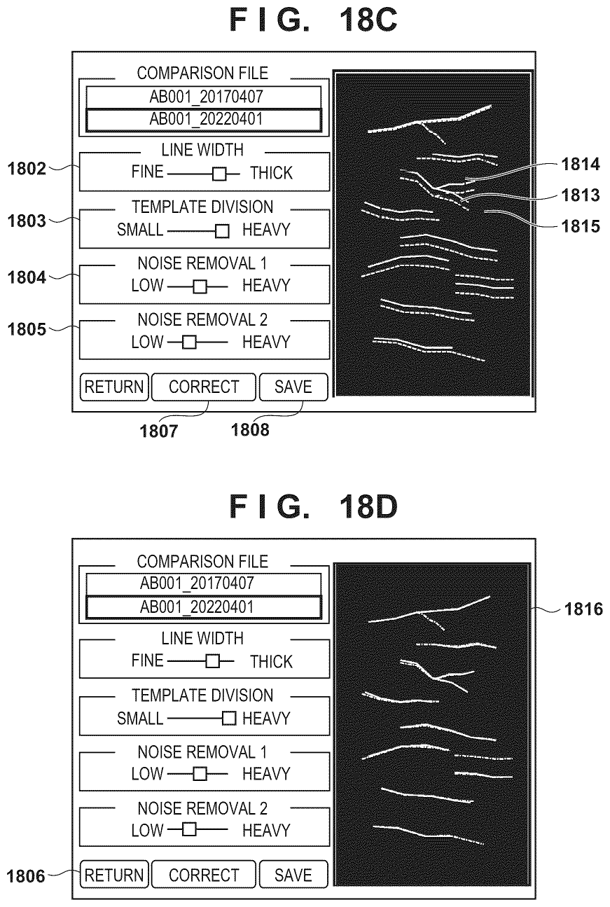

FIGS. 18A to 18D are examples of GUI screens displayed by the information processing apparatus 1700 according to the present embodiment. These GUI screens are implemented using a window system provided by the OS running on the information processing apparatus 100. As illustrated in FIG. 18A, GUI elements 1801 to 1809 is disposed in a main window 1800.

In FIG. 18A, when the region of the file list 1801 is clicked by the operator using the operation unit 106 (for example, the mouse), the control unit 1701 displays a file selection dialog (not illustrated). Using the file selection dialog, the operator designates two polyline data files and the order of the obtaining time period (imaging timing), and the control unit 1701 stores this result. Note that the imaging timing may be stored in association with the polyline data, and in this case, the order of the imaging timing may be selected on the basis of the associated information, irrespective of a user operation.

When designation of the polyline data files has ended, the control unit 1701 displays the file names in the designated obtaining time period order in the file list 1801. Next, the display control unit 1702 displays the polylines included in each file superimposed in the polyline display region 1809. FIG. 18B illustrates a screen after file selection, with two file names being displayed in a field 1810 and the polyline of each file displayed in different colors (in the diagram this is represented by different line types) in a polyline display region 1812.

The control unit 1701 stores which of the two selected files is to be used as the transformation target as a variable, and the file name of the transformation target is highlighted as with 1811. Here, the operator can click on a file name in the file list 1801 to switch the transformation target, but the image for transformation may be set as in the first embodiment.

When the operator clicks and selects the polyline of the polylines displayed in the display region 1812 which has an older obtaining time period (indicated with a solid line in FIGS. 18A to 18D), the display control unit 1702 changes the polyline display region as illustrated in FIG. 18C. When the operator slides the thumb of the line width slider 1802, the control unit 1701 determines, according to the slide position, the line width for drawing the polyline when generating a template image and a target object image in steps S503 and S504 in FIG. 5. An example of such a display of a polyline changed to a determined line width is display 1813.

Also, the display control unit 1702 displays a template region 1814 determined in step S501 and a region 1815 of the target object image determined in step S502 relating to the selected polyline. The control unit 1701 determines and stores a value for the target area of the target widths 713 to 716 in FIG. 7B depending on the input by the operator for the movement and scale up/down of the region 1815 of the target object image. The line width and the target area are designated by the operator selecting any polyline. However, this is not necessarily performed for each one of the polylines, and the user-designated value may be applied to all of the polylines. Note that the line width and the target area can be set for each of the polylines.

The template division slider 1803 illustrated in FIGS. 18A to 18D is for designating the setting for template division described in the first modified example of the first embodiment. For example, when the slider 1803 is at “Large”, template division is not performed, and when the slider 1803 is at “Small”, the polylines are divided into smaller parts. For example, the constant L of Formula (4) is changed 20% of the maximum value of the polyline length between “Large” and “Small”.

The first slider 1804 for noise removal and the second slider 1805 for noise removal illustrated in FIGS. 18A to 18D are used to designate the threshold used in the outlier removal processing of steps S1202 and S1206 of FIG. 12. For example, the constant multiplied by the standard deviation used as each of the thresholds is designated within a range from 0.5 to 4.0.

Note that though not included in the GUI elements illustrated in FIGS. 18A to 18D, other GUI elements relating to parameters such as a constant used in the weighting of step S1204 may be provide, and input relating to these parameters may be accepted.

Also, parameters that can be designated via 1801 to 1805 and 1814 illustrated in FIGS. 18A to 18D may use a default value if a value is not designated by the operator. Also, by the operator clicking the parameter store button 1808, the value held in the various GUIS at that time are stored in the HDD 104 as a file.

When the operator clicks the start correction button 1807 as illustrated in FIG. 18C, using the parameter values held at that time, the processing illustrated in FIGS. 5, 9, and 12 and the coordinate transformation of the polylines of the image for transformation are executed, and the results are displayed in the polyline display region 1809. FIG. 18D illustrates a screen after coordinate transformation, and as illustrated in a display screen 1816, polylines (solid lines) of the reference image and polylines (dot-dash lines) after coordinate transformation are superimposed. When the operator clicks the return button 1806 in the GUI illustrated in FIG. 18D, the screen of FIG. 18C is returned to, and the parameters can be adjusted by operator input.

According to this configuration, an information processing apparatus can be provided that is configured to, in addition to executing each process described in the first embodiment, designate parameters used in coordinate transformation and display the results of the coordinate transformation. This has the effect of providing an interactive GUI to the operator and being able to efficiently prompt the operator to set the appropriate parameters. Another effect includes being able to reuse polyline data obtained with similar conditions by storing the determined parameters in an external storage apparatus.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-096466, filed Jun. 12, 2023 which is hereby incorporated by reference herein in its entirety.

What is claimed is:

1. An information processing apparatus, comprising:
at least one processor; and
a memory configured to combine with the at least one processor, and when executed by the processor, the memory includes a command for executing operations as:
an obtaining unit configured to obtain first position information indicating a position of a target detected in a first image captured of a target object and second position information indicating a position of the target detected in a second image captured of the target object at a different time from the first image;
an estimating unit configured to estimate a position shift amount of the target on a basis of the first position information and the second position information; and
a correcting unit configured to correct at least one of the first position information and the second position information on a basis of the position shift amount,
wherein the first position information includes information of each vertex of the target in the first image, and the second position information includes information of each vertex of the target in the second image.

2. The information processing apparatus according to claim 1, wherein
the obtaining unit obtains, as the first position information, a first polyline data group including one or more pieces of polyline data in which a shape of the target in the first image is indicated by information of each vertex and, as the second position information, a second polyline data group including one or more pieces of polyline data in which a shape of the target in the second image is indicated by information of each vertex.

3. The information processing apparatus according to claim 2, further comprising:
a first generating unit configured to, on a basis of the position shift amount, generate a function for transforming coordinates in a coordinate system of first polyline data included in the first polyline data group to coordinates in a coordinate system of second polyline data included in the second polyline data group,
wherein the correcting unit corrects coordinates indicated by the first polyline data on a basis of the function.

4. The information processing apparatus according to claim 3, wherein
the estimating unit estimates a similarity between polyline data included in the first polyline data group and polyline data included in the second polyline data group as the position shift amount, and
the first generating unit generates the function on a basis of the similarity.

5. The information processing apparatus according to claim 4, further comprising:
a second generating unit configured to generate a target object image corresponding to the first polyline data on a basis of the first polyline data included in the first polyline data group and generating a template image corresponding to the second polyline data on a basis of the second polyline data included in the second polyline data group,
wherein the estimating unit, via template matching using the template image and the target object image, estimates a similarity of polyline data for each position of the template image.

6. The information processing apparatus according to claim 5, wherein
the second generating unit generates a bounding box region of the first polyline data as the target object image.

7. The information processing apparatus according to claim 5, wherein
the second generating unit generates a bounding box region of the second polyline data as the template image.

8. The information processing apparatus according to claim 7, wherein
the template image is an image including a gradient of pixel values in a line width direction centered on the first polyline data in the bounding box region.

9. The information processing apparatus according to claim 5, wherein
the second generating unit generates, as the template image, a partial region of a divided region including the first polyline data.

10. The information processing apparatus according to claim 5, wherein
the second generating unit generates, as the template image, a bounding box region of third polyline data including the third polyline data obtained by dividing the first polyline data.

11. The information processing apparatus according to claim 5, further comprising:
a calculating unit configured to calculate a vector between a position of the template image before the template matching and a position where the similarity is maximum,
wherein the first generating unit generates the function on a basis of the vector calculated by the calculating unit from a plurality of pieces of polyline data included in the first polyline data group.

12. The information processing apparatus according to claim 11, wherein
the first polyline data is included in polyline data included in the first polyline data group with polyline data in which the vector is an outlier being removed.

13. The information processing apparatus according to claim 12, further comprising:
a corrective unit configured to correct the function in a case where, of polyline data included in the first polyline data group, a number of pieces of polyline data after removing polyline data in which the vector is an outlier is less than a predetermined threshold.

14. The information processing apparatus according to claim 11, wherein the first generating unit generates a model function for outputting an X component or a Y component of the vector as the function, where a position of the first polyline data in the target object image is used as an input.

15. The information processing apparatus according to claim 14, further comprising:
a setting unit configured to set a weighting for each vector calculated by the calculating unit,
wherein the first generating unit generates the model function also on a basis of weighting for each vector.

16. The information processing apparatus according to claim 3, further comprising:
a determining unit configured to determine whether or not imaging conditions of the first image and a third image are similar,
wherein the first generating unit, for the third image determined to have similar imaging conditions to the first image, generates a function for transforming coordinates in a coordinate system of fourth polyline data included in a third polyline data group including one or more pieces of polyline data in which a shape of a target in the third image is indicated by information of each vertex to coordinates in a coordinate system of the second polyline data as a function identical to a function for transforming coordinates in a coordinate system of the first polyline data to coordinates in a coordinate system of the second polyline data.

17. The information processing apparatus according to claim 5, wherein a number of pieces of polyline data included in the first polyline data group is less than a number of pieces of polyline data included in the second polyline data group.

18. The information processing apparatus according to claim 3, further comprising:
a second obtaining unit configured to obtain input of an operator;
a setting unit configured to set a parameter to be used in correction processing using the function on a basis of an input obtained by the second obtaining unit; and
a presenting unit configured to present to the operator a coordinates correction result from the correcting unit.

19. The information processing apparatus according to claim 1, further comprising:
a displaying unit configured to display polyline data in which a shape of the target is indicated by information of each vertex on a display apparatus on the basis of at least one of the first position information and the second position information corrected by the correcting unit.

20. The information processing apparatus according to claim 1, wherein the target object is a construction, and the target is deformation of the construction.

21. An information processing method, comprising:
obtaining first position information indicating a position of a target detected in a first image captured of a target object and second position information indicating a position of the target detected in a second image captured of the target object at a different time from the first image;
estimating a position shift amount of the target on a basis of the first position information and the second position information; and
correcting at least one of the first position information and the second position information on a basis of the position shift amount,
wherein the first position information includes information of each vertex of the target in the first image, and the second position information includes information of each vertex of the target in the second image.

22. A non-transitory computer readable storage medium storing a program that, when executed by a computer, causes the computer to perform an information processing method, the information processing method comprising:
obtaining first position information indicating a position of a target detected in a first image captured of a target object and second position information indicating a position of the target detected in a second image captured of the target object at a different time from the first image;
estimating a position shift amount of the target on a basis of the first position information and the second position information; and
correcting at least one of the first position information and the second position information on a basis of the position shift amount,
wherein the first position information includes information of each vertex of the target in the first image, and the second position information includes information of each vertex of the target in the second image.
